(19) United States
(12) Patent Application Publication
(10) Pub. No.: US 2025/0015543 A1
(43) Pub. Date: Jan. 9, 2025

(54) BATTERY-POWERED DEVICE

(71) Applicant: MAKITA CORPORATION, Anjo-shi (JP)

(72) Inventors: Akira NIWA, Anjo-shi (JP); Hitoshi SUZUKI, Anjo-shi (JP)

(73) Assignee: MAKITA CORPORATION, Anjo-shi (JP)

(21) Appl. No.: 18/754,820

(22) Filed: Jun. 26, 2024

(30) Foreign Application Priority Data
Jul. 3, 2023 (JP) 2023-109496

(51) Int. Cl. H01R 13/66; H01R 13/26; H01R 13/447; H01R 31/06

(52) U.S. Cl. CPC H01R 13/6691; H01R 13/26; H01R 13/447; H01R 31/065; H01R 2201/10

(57) ABSTRACT

A battery-powered device in one aspect of the present disclosure includes a battery port, an electric load, a controller, and a terminal block. To the battery port, a battery pack including a first battery is attached. The electric load operates with first electric power of the first battery. The terminal block includes two or more machine-side terminals, a battery holder, and a wireless communicator. The two or more machine-side terminals are coupled to two or more battery-side terminals of the battery pack, respectively. In the battery holder, a second battery is removably held. The wireless communicator (i) receives second electric power from the second battery (ii) and performs a wireless communication.

### CROSS-REFERENCE TO RELATED APPLICATIONS

This application claims the benefit of Japanese Patent Application No. 2023-109496 filed with the Japan Patent Office on Jul. 3, 2023, the entire disclosure of Japanese Patent Application No. 2023-109496 is incorporated herein by reference.

### BACKGROUND

The present disclosure relates to a battery-powered device.

The Japanese translation of PCT International Application Publication No. 2018-537298 discloses a handheld power tool including a wireless module. The wireless module operates by receiving electric power from a button cell battery. The wireless module can wirelessly communicate with external interfaces.

### SUMMARY

The above-described handheld power tool includes a handle, and the handle includes a cup-shaped opening. The opening accommodates the wireless module and the button cell battery. The opening is provided with a cover. That is, the cover is placed on the side of the handle. The cover closes the opening.

The placement of the cover on the side of the handle may cause damage to the appearance and/or usability of the handheld power tool. For example, the appearance of the handheld power tool can be spoiled. In addition, for example, a user's hand is more likely to touch the cover of the handheld power tool while in use. Touching the cover by hand can affect the user's usability.

In one aspect of the present disclosure, it is desirable to provide a technique for equipping a battery-powered device with a wireless communicator while reducing influence on the appearance and user's usability of the battery-powered device.

One aspect of the present disclosure is to provide a battery-powered device including a battery port, an electric load, a controller, and a terminal block. To the battery port, a battery pack is detachably attached. The battery pack includes a first battery and two or more battery-side terminals. The electric load receives a first electric power of the first battery from the battery pack to thereby operate. The controller controls the electric load.

The terminal block includes two or more machine-side terminals, a battery holder, and a wireless communicator. The two or more machine-side terminals are (i) coupled to the two or more battery-side terminals, respectively and (ii) receive the first electric power through the two or more battery-side terminals, based on the battery pack being attached to the battery port. In the battery holder, a second battery is removably held. The wireless communicator (i) receives a second electric power from the second battery (ii) and performs a wireless communication.

In this battery-powered device, the terminal block is basically provided to electrically couple the battery pack to the battery-powered device. The battery holder and the wireless communicator are arranged in this terminal block. Therefore, the wireless communicator can be mounted on the battery-powered device while minimizing damage to the appearance and the usability of the battery-powered device.

One aspect of the present disclosure is to provide a method for installing a wireless communicator in a battery-powered device, the method including:
providing the wireless communicator to a terminal block, the terminal block including a machine-side terminal configured to be coupled to a battery-side terminal of a battery pack, and the battery pack being configured to be detachably coupled to the battery-powered device; and
providing the terminal block equipped with the wireless communicator to the battery-powered device.

Such a method can exhibit effects similar to those of the battery-powered device.

In the above-described Patent Document 1, the handheld power tool includes a wireless module. Thus, if the handheld power tool has a useful function using the wireless module, the handheld power tool can enhance its added value.

Thus, still another aspect of the present disclosure is to provide a battery-powered device in which added value is enhanced by the wireless communicator.

Specifically, the present disclosure includes the following items.

[Item A1]

A battery-powered device including at least one of:
a battery port configured to detachably attach a battery pack thereto, the battery pack including a first battery;
an electric load configured to receive a first electric power of the first battery from the battery pack to thereby operate;
a controller configured to control the electric load (or an operation of the electric load);
a battery holder configured to removably hold a second battery; and
a wireless communicator (or a first wireless communicator) configured to
receive a second electric power from the second battery,
perform a wireless communication with an external system (or a second wireless communicator) distinct from the wireless communicator according to a first communication protocol (or a first communication method), and
perform a data communication with the battery pack according to a second communication protocol (or a second communication method) based on the battery pack being attached to the battery port, the second communication protocol being different from the first communication protocol.

In this battery-powered device, the wireless communicator can perform a data communication with the battery pack. Therefore, it is possible to provide a highly value-added battery-powered device.

[Item A2]

The battery-powered device according to the above-described item A1, wherein the wireless communicator is configured (i) to receive the first electric power from the first battery and (ii) to operate with the first electric power, while the battery pack is attached to the battery port.

[Item A3]

The battery-powered device according to the above-described item A2, including at least one of:
a power supply circuit configured (i) to receive the first electric power while the battery pack is attached to the battery port and (ii) to generate a power-supply power from the first electric power, the power-supply power operating the wireless communicator; and
a communication power supply circuit configured to deliver the power-supply power to the wireless communicator,
wherein, optionally, the wireless communicator is configured (i) to receive the power-supply power and (ii) to operate with the power-supply power.

[Item A4]

The battery-powered device according to the above-described item A3,
wherein the communication power supply circuit is configured to
   receive the second electric power from the second battery, and supply the second electric power to the wireless communicator while the power-supply power is not generated in the power supply circuit, and/or
   supply the power-supply power to the wireless communicator while the power-supply power is generated in the power supply circuit.

[Item A5]

The battery-powered device according to any one of the above-described items A1 through A4,
wherein the wireless communicator is configured to
   store third information based on having received the third information from the external system, and/or
   transmit the third information, which is stored, to the battery pack through a data communication based on the battery pack having been attached to or being attached to the battery port.

[Item A6]

The battery-powered device according to the above-described item A5,
wherein the battery pack is configured to be set to a first mode,
wherein the battery pack is configured to stop (or forcibly stop) a supply of the first electric power to the battery-powered device based on the battery pack being set to the first mode, and
wherein optionally, the battery pack is configured to cancel the first mode based on (i) the battery pack being set to the first mode and (ii) having received the third information.

The third information may request that the first mode be cancelled. Cancelling the first mode may include permitting or starting the supply of the first electric power to the battery-powered device.

In addition, one aspect of the present disclosure includes the following items.

[Item B1]

A battery-powered device including at least one of:
a battery port configured to detachably attach a battery pack thereto, the battery pack including a first battery;
an electric load configured to receive a first electric power of the first battery from the battery pack to thereby operate;
a controller configured to control the electric load (or an operation of the electric load);
a battery holder configured to removably hold a second battery, and
a wireless communicator (or a first wireless communicator) configured to
   receive a second electric power from the second battery, and/or
   perform a wireless communication with an external system (or a second wireless communicator) distinct from the wireless communicator according to a first communication protocol (or a first communication method), and/or
   perform a first data communication with the battery pack and/or the controller according to a second communication protocol (or a second communication method) based on the battery pack being attached to the battery port, the second communication protocol being different from the first communication protocol.

In this battery-powered device, the wireless communicator can perform the first data communication with the battery pack and/or the controller. Therefore, it is possible to provide a highly value-added battery-powered device.

[Item B2]

The a battery-powered device according to the above-described item B1,

wherein the wireless communicator is configured (i) to receive the first electric power from the first battery and (ii) to operate with the first electric power, while the battery pack is attached to the battery port.

[Item B3]

The battery-powered device according to the above-described item B1 or B2,

wherein the wireless communicator is configured to perform the first data communication with any one of the battery pack and the controller based on the battery pack having been attached to or being attached to the battery port.

[Item B4]

The battery-powered device according to the above-described item B3 including at least one of:
a communication path to be used for a second data communication between the battery pack and the controller,
a first switch and a second switch (i) arranged in series on the communication path and (ii) configured to each complete (or connect) or interrupt (or disconnect) the communication path, and (iii) wherein the first switch is arranged on a battery pack side relative to the second switch,
wherein optionally, the wireless communicator is electrically coupled to a path (or a first path, or a part of the communication path) between the first switch and the second switch in the communication path, and
wherein optionally, the wireless communicator is configured to
   perform the first data communication with the battery pack through the first switch, and/or
   perform the first data communication with the controller through the second switch.

The first switch may include a first end and a second end, and the second switch may include a third end and a fourth end. The first end may be electrically coupled to the battery pack. The second end may be electrically coupled to the third end. The fourth end may be electrically coupled to the controller.

[Item B5]

The a battery-powered device according to the above-described item B4,
wherein the wireless communicator is configured to
   (i) cause the first switch to interrupt the communication path, (ii) cause the second switch to complete the communication path, and (iii) perform the first data communication with the controller through the second switch, and/or
   (i) cause the first switch to complete the communication path, (ii) cause the second switch to interrupt the communication path, and (iii) perform the first data communication with the battery pack through the first switch

In addition, one aspect of the present disclosure includes the following items.

[Item C1]

A battery-powered device including at least one of:
a battery port configured to detachably attach a battery pack thereto, the battery pack including a first battery;
an electric load configured to receive a first electric power of the first battery from the battery pack to thereby operate;
a controller configured to control the electric load (or an operation of the electric load);
a battery holder configured to removably hold a second battery, and
a wireless communicator (or a first wireless communicator) configured to:
   (i) receive a second electric power from the second battery, and (ii) perform a wireless communication with an external system (or a second wireless communicator) according to a first communication protocol (or a first communication method) based on the battery pack being detached from the battery port; and/or
   perform a data communication with the controller according to a second communication protocol (or a second communication method) based on the battery pack being attached to the battery port, the second communication protocol being different from the first communication protocol; and/or
   avoid the data communication with the controller based on the battery pack being detached from the battery port.

In this battery-powered device, the wireless communicator can perform a data communication with the controller. Therefore, it is possible to provide a highly value-added battery-powered device.

[Item C2]

The battery-powered device according to the above-described item C1,

wherein the wireless communicator is configured (i) to receive the first electric power from the first battery and (ii) to operate with the first electric power while the battery pack is attached to the battery port.

[Item C3]

The battery-powered device according to the above-described item C1 or C2,
wherein the wireless communicator is configured to
   store fourth information based on having received the fourth information from the external system, and
   optionally transmit the fourth information, which is stored, to the controller through the data communication based on the battery pack having been attached to or being attached to the battery port.

[Item C4]

The battery-powered device according to the above-described item C3,
wherein the controller is configured to be set to a second mode,
wherein the controller is configured to stop (or forcibly stop) an operation and/or a control of the electric load based on the controller being set to the second mode, and
wherein optionally, the controller is configured to cancel the second mode based on (i) the controller being set to the second mode and (ii) having received the fourth information.

The fourth information may request that the second mode be cancelled. Cancelling the second mode may include permitting or starting the operation and/or the control of the electric load.

### BRIEF DESCRIPTION OF THE DRAWINGS

Some example embodiments of the present disclosure are described hereinafter by way of example with reference to the accompanying drawings, in which:

FIG. 1 is a perspective view of an electric work machine of a first embodiment;

FIG. 2 is a perspective view of a work machine body with a battery pack removed as seen from the below;

FIG. 3 is a perspective view of a terminal block as seen from above;

FIG. 4 is a front view of the terminal block;

FIG. 5 is a top view of the terminal block;

FIG. 6 is a perspective view of the terminal block as seen from the below;

FIG. 7 is a perspective view of the terminal block with a cover removed as seen from the below;

FIG. 8 is a bottom view of the terminal block;

FIG. 9 is an IX-IX cross-sectional view of the terminal block shown in FIG. 3;

FIG. 10 is an explanatory diagram showing an electrical configuration of the electric work machine of the first embodiment;

FIG. 11 is a flowchart showing a part of a process flow related to electronic locking in the first embodiment;

FIG. 12 is a flowchart showing the remaining part of the process flow related to the electronic locking in the first embodiment (continuation of FIG. 11);

FIG. 13 is an explanatory diagram showing an electrical configuration of an electric work machine of a second embodiment;

FIG. 14 is a flowchart showing a part of a process flow related to electronic locking in the second embodiment;

FIG. 15 is a flowchart showing another part of the process flow related to the electronic locking in the second embodiment (continuation of FIG. 14); and

FIG. 16 is a flowchart showing the remaining part of the process flow related to the electronic locking in the second embodiment (continuation of FIG. 15).

### DETAILED DESCRIPTION OF EXEMPLARY EMBODIMENTS

### 1. Overview of Embodiments

One embodiment may provide a battery-powered device including at least any one of the following features 1 through 9:
Feature 1: a battery port configured to detachably attach a battery pack thereto. The battery pack may include a first battery. The battery pack may include two or more battery-side terminals;
Feature 2: an electric load configured to receive a first electric power of the first battery from the battery pack to thereby operate;
Feature 3: a controller configured to control the electric load (or an operation of the electric load);
Feature 4: a terminal block;
Feature 5: the terminal block includes two or more machine-side terminals;
Feature 6: the two or more machine-side terminals are configured to be coupled (or electrically coupled) to the two or more battery-side terminals, respectively, based on the battery pack being attached to the battery port;
Feature 7: the two or more machine-side terminals are configured to receive the first electric power through the two or more battery-side terminals based on the battery pack being attached to the battery port;
Feature 8: the terminal block includes a battery holder configured to removably hold a second battery. The battery holder may be in or on the terminal block;
Feature 9: the terminal block includes a wireless communicator configured (i) to receive second electric power from the second battery and (ii) to perform a wireless communication. The wireless communicator may be fixed in or on the terminal block.

In the battery-powered device including at least features 1 through 9, the battery holder and the wireless communicator are arranged in the terminal block. Therefore, the wireless communicator can be mounted on the battery-powered device while inhibiting damage to the appearance and the usability of the battery-powered device.

The battery-powered device may include a housing. The housing may house the controller. The housing may house an electric load. The housing may include an opening. The battery port may be arranged in the opening. The terminal block may block some or all of the opening. Based on the battery pack being attached to the battery port, some or all of the terminal block may be covered by the battery pack. Based on some or all of the terminal block being covered by the battery pack, a user of the battery-powered device may be unable to visually observe the terminal block from outside the terminal block. The electric load may include a motor.

The two or more battery-side terminals may include (i) a positive electrode connection terminal coupled to the positive electrode of the first battery, (ii) a negative electrode connection terminal coupled to the negative electrode of the first battery, and/or (iii) one or more battery auxiliary terminals. The one or more battery auxiliary terminals may include one or more battery communication terminals and/or one or more battery signal terminals.

The two or more machine-side terminals may include (i) a machine positive electrode terminal configured to be coupled to the positive electrode connection terminal, (ii) a machine negative electrode terminal configured to be coupled to the negative electrode connection terminal, and/or (iii) one or more machine auxiliary terminals. The one or more machine auxiliary terminals may include one or more machine communication terminals and/or one or more machine signal terminals. The one or more machine auxiliary terminals may be configured to be coupled to the one or more battery auxiliary terminals, respectively.

One embodiment may include the following feature 10 in addition to or in place of the at least any one of the above-described features 1 through 9:
Feature 10: a holding body holding the two or more machine-side terminals. The holding body may include a first surface and a second surface. The second surface corresponds to a back surface of the first surface. That is, the first surface and the second surface are front and back sides of the holding body. The second surface may face (or directly face) the battery pack based on the battery pack being attached to the battery port. The second surface may include a terminal arrangement area in which the two or more machine-side terminals are arranged.

One embodiment may include the following Feature 11 in addition to or in place of the at least any one of the above-described features 1 through 10:
Feature 11: the battery holder is on the second surface. The battery holder may extend from the second surface to the inside of the holding body.

The battery-powered device including at least features 1 through 11 can easily hold the second battery in the battery holder and easily remove the second battery pack from the battery holder.

One embodiment may include the feature 12 in addition to or in place of at least any one of the above-described features 1 through 11. The feature 12 may include the following feature 12a and/or feature 12b.
Feature 12a: the second surface includes a holder arrangement area distinct from the terminal arrangement area.
Feature 12b: the battery holder is in the holder arrangement area.

In the battery-powered device including at least features 1 through 12, the second surface of the terminal block is effectively used. Thus, it is possible to inhibit or prevent the upsizing of the entire terminal block (including the battery holder).

One embodiment may include at least any one of the following features 13 through 14 in addition to or in place of at least any one of the above features 1 through 12;
Feature 13: the battery port is configured to detachably attach the battery pack thereto by sliding the battery pack in a first direction (or an insertion direction) on the battery port. The first direction may intersect or be perpendicular to a second direction. The second direction is a direction in which the battery pack attached to the battery port and the battery port face each other. The second direction may intersect or be perpendicular to the first surface and/or the second surface.
Feature 14: the battery holder is spaced apart from the two or more battery-side terminals in the first direction in a pack attached state. The pack attached state corresponds to a state where the battery pack is attached to the battery port.

The battery holder may be spaced apart from the terminal arrangement area (i.e., from the two or more machine-side terminals) in the first direction. In other words, the holder arrangement area may be spaced apart from the terminal arrangement area in the first direction.

The battery-powered device including at least features 1 through 9 and 13 through 14 can inhibit the battery holder from influencing or interfering with the attachment and detachment of the battery pack.

One embodiment may include the following feature 15 in addition to or in place of the at least any one of the above-described features 1 through 14:
Feature 15: the wireless communicator is spaced apart from the battery holder.

In the battery-powered device including at least features 1 through 9 and 15, the battery holder and the wireless communicator are separated from each other. Therefore, it is possible to effectively arrange the battery holder and the wireless communicator in the terminal block while inhibiting the upsizing of the terminal block.

One embodiment may include the following feature 16 in addition to or in place of the at least any one of the above-described features 1 through 15:
Feature 16: the wireless communicator is on the first surface. The entirety of the wireless communicator may be (directly or indirectly) on the first surface. A part of the wireless communicator may be inside the holding body through the first surface.

In the battery-powered device including at least features 1 through 10 and 16, the wireless communicator is arranged on the first surface, not on the second surface where the two or more machine-side terminals are arranged. Therefore, it is possible to protect the wireless communicator from foreign matters such as dust, dirt, and water.

One embodiment may include the following feature 17 or features 17 through 18 in addition to or in place of at least any one of the above-described features 1 through 16:
Feature 17: the terminal block includes the cover configured to cover the battery holder;
Feature 18: the cover is configured to be fixed to the terminal block by a screw.

The battery-powered device including at least features 1 through 9 and 17 can suitably hold the second battery in the battery holder.

One embodiment may include at least any one of the following features 19 and 20 in addition to the above-described feature 17.
Feature 19: the terminal block includes a sealing member. The sealing member may be on the cover or on a cover receiving surface. The cover receiving surface may be arranged on the terminal block separately from the cover. The cover receiving surface may be configured to face the cover.
Feature 20: the sealing member is configured to be in close contact with both the cover and the cover receiving surface based on the battery holder being covered by the cover, thereby sealing the battery holder together with the cover.

The sealing member may be arranged on the cover, for example. Specifically, the sealing member may be arranged on and/or near the outer peripheral surface of the cover in an encircling manner. The outer peripheral surface faces the terminal block. The outer peripheral surface may face the cover receiving surface. In this case, based on the battery holder being covered by the cover, the sealing member is in close contact with the terminal block (more specifically, to the cover receiving surface), thereby sealing the battery holder.

Conversely, the sealing member may be arranged on the cover receiving surface, for example. Specifically, the sealing member may be arranged on the cover receiving surface in an encircling manner. Alternatively, the cover receiving surface may have an encircling shape. The cover receiving surface may be arranged on the battery holder (e.g., on the opening of the battery holder) in an encircling manner. In this case, based on the battery holder being covered by the cover, the sealing member is in close contact with the cover, thereby sealing the battery holder.

The battery-powered device including at least features 1 through 9, 17, 19, and 20 can inhibit or prevent foreign matters such as dust, dirt, water, from entering the battery holder.

One embodiment may include at least any one of the following features 21 through 22 in addition to or in place of at least any one of the above features 1 through 20.
Feature 21: the wireless communicator is configured to forcibly set the battery-powered device to an inoperable state based on having received first information through a wireless communication. The inoperable state corresponds to a state in which the electric load cannot operate.
Feature 22: the wireless communicator is configured to cancel the inoperable state based on (i) the battery-powered device being in the inoperable state and (ii) having received second information via the wireless communication.

The wireless communicator may be configured to execute an inoperability setting process. The inoperability setting process includes forcibly setting the battery-powered device to the inoperable state based on having received the first information via the wireless communication. The wireless communicator may be configured to execute a cancellation process. The cancellation process includes cancelling the inoperable state based on (i) the battery-powered device being in the inoperable state and (ii) having received the second information via the wireless communication.

When the battery-powered device includes at least features 1 through 9, 21, and 22, it is possible to set the battery-powered device to the inoperable state via the wireless communication.

One embodiment may include at least any one of the following features 23 through 25 in addition to or in place of at least any one of the above features 1 through 22;
Feature 23: the two or more machine-side terminals includes information input terminal configured to receive permission information from the battery pack. The permission information indicates permission for an operation of the electric load.
Feature 24: the controller is configured to operate the electric load based on (i) having received a command of the operation of the electric load and (ii) having received the permission information through the information input terminal.
Feature 25: the wireless communicator is configured to interrupt an input of the permission information to the controller to thereby set the battery-powered device to the inoperable state.

The inoperability setting process may include interrupting the input of the permission information to the controller to thereby set the battery-powered device to the inoperable state.

When the battery-powered device includes at least features 1 through 9, 21 through 25, it is possible to easily set the battery-powered device to the inoperable state.

One embodiment may include at least any one of the following features 26 through 29 in addition to or in place of at least any one of the above features 1 through 25;
Feature 26: the terminal block includes an information transmission path configured to transmit, to the controller, the permission information input to the information input terminal.
Feature 27: the terminal block includes a first switch configured to complete or interrupt the information transmission path.
Feature 28: the wireless communicator is configured to cause the first switch to interrupt the information transmission path to thereby set the battery-powered device to the inoperable state.
Feature 29: the wireless communicator is configured to cause the first switch to complete the information transmission path to thereby cancel the inoperable state.

The feature 28 may be included in the inoperability setting process, and the feature 29 may be included in the cancellation process.

In the battery-powered device including at least features 1 through 9, 21 through 29, it is possible to easily set the battery-powered device to the inoperable state and to easily cancel the inoperable state.

One embodiment may provide a method for installing a wireless communicator in a battery-powered device, the method including at least one of the following features 30 and 31:
Feature 30: providing the wireless communicator to a terminal block. The terminal block may include a machine-side terminal. The machine-side terminal may be configured to be coupled to a battery-side terminal of a battery pack. The battery pack may be configured to be detachably coupled to the battery-powered device.
Feature 31: providing the terminal block equipped with the wireless communicator to the battery-powered device.

In the method including the features 31 and 32, the wireless communicator can be installed in the battery-powered device while minimizing damage to the appearance and the usability of the battery-powered device.

One embodiment may include the following feature 32 in addition to or in place of at least one of the above features 30 and 31:
Feature 32: providing a battery holder to the terminal block. The battery holder may be configured to removably hold a second battery that is distinct from the battery pack. The wireless communicator may be configured to receive an electric power from the second battery to thereby operate.

In one embodiment, the above-described features 1 through 32 may be combined in any combinations.

In one embodiment, any of the above-described features 1 through 32 may be excluded.

Examples of the battery-powered device include various job-site electric apparatuses configured to be driven by batteries and used in job-sites, such as home carpentry, manufacturing, gardening, and construction. Specifically, examples of the battery-powered device include an electric power tool for masonry work, metalworking, or woodworking, a work machine for gardening, and a device for preparing an environment of a job site. More specifically, examples of the battery-powered device include an electric blower, an electric hammer, an electric hammer drill, an electric drill, an electric driver, an electric wrench, an electric grinder, an electric circular saw, an electric reciprocating saw, an electric jigsaw, an electric cutter, an electric chainsaw, an electric planer, an electric nail gun (including a tacker), an electric hedge trimmer, an electric lawn mower, an electric lawn trimmer, an electric bush cutter, an electric cleaner, an electric sprayer, an electric spreader, an electric dust collector, a laser distance meter (or a laser distance measuring instrument), a laser marking device, an optical receiver of a laser making device, a wall scanner, a radio, a television, a speaker, a light (i.e., a lighting device), an electric cold/warm storage, an electric kettle, a coffee machine (or a coffee maker or a coffee distillation device), a microwave oven, a robot cleaner (or a robot vacuum), a battery-powered wheel barrow, a battery-powered bicycle, a fan vest, and a heating jacket.

In one embodiment, the controller may be in the form of a control circuit. The control circuit may be integrated into a single electronic unit or a single electronic device or a single circuit board.

In one embodiment, the control circuit may be a combination of two or more electronic circuits or two or more electronic units or two or more electronic devices provided separately within the electric work machine.

In one embodiment, the control circuit may include a microcomputer (or a microcontroller or a microprocessor), a wired logic, an application specific integrated circuit (ASIC), an application specific standard product (ASSP), a programmable logic device (such as a field programmable gate array (FPGA)), a discrete electronic component, and/or combinations thereof.

In one embodiment, the switch may be a semiconductor switch or a mechanical relay. Examples of the semiconductor switch include a field effect transistor (FET), a bipolar transistor, an insulated gate bipolar transistor (IGBT), a bidirectional buffer, and a solid-state relay (SSR).

### 2. Specific Exemplary Embodiments

Hereinafter, some embodiments of the present disclosure are described by way of example.

### 2-1. First Embodiment

### (2-1-1) Configuration of Electric Work Machine

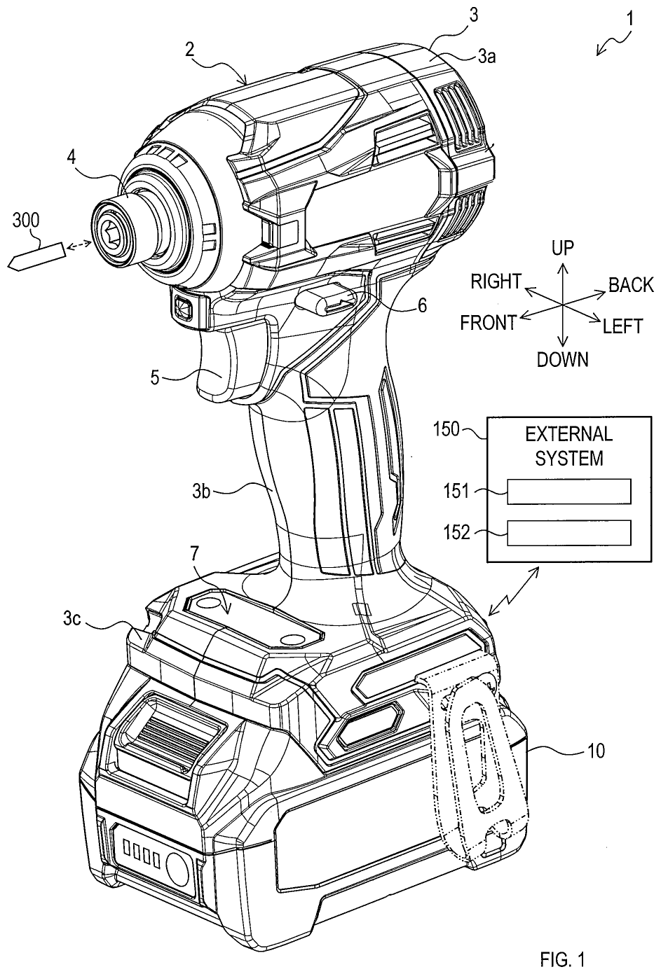

An electric work machine 1 of a first embodiment shown in FIG. 1 is, for example, in the form of an impact driver. The impact driver is used to tighten screws, bolts, nuts, and the like to an object and to loosen them from the object.

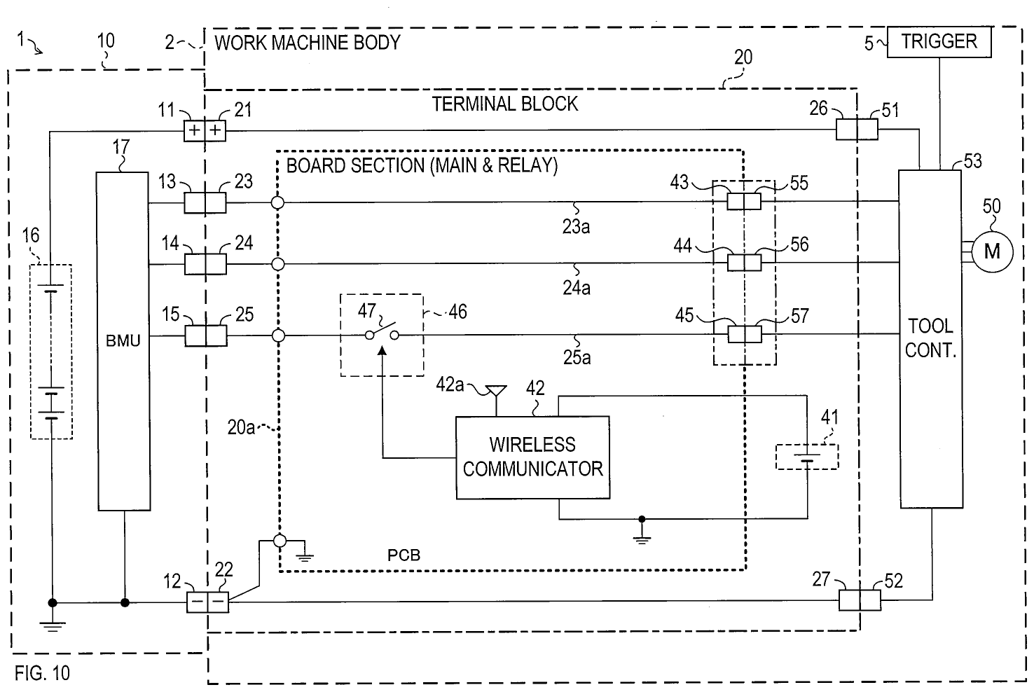

As shown in FIG. 1, electric work machine 1 includes a work machine body 2 and a battery pack 10. The battery pack 10 is detachably attached to the work machine body 2. The battery pack 10 includes a first battery 16 (see FIG. 10). The first battery 16 supplies a first electric power to the work machine body 2. The first battery 16 can be recharged repeatedly. The first battery 16 may be, for example, a lithium ion battery. The first battery 16 may be a non-rechargeable battery.

The work machine body 2 includes a housing 3. The housing 3 includes a motor container 3a.

The motor container 3a houses an electric load 50 (see FIG. 10), a transmission mechanism (not shown), and the like as described below.

The housing 3 includes a grip 3b. The grip 3b is located below the motor container 3a. A user of the electric work machine 1 can hold the grip 3b with one hand.

The housing 3 includes a chuck sleeve 4. The chuck sleeve 4 is located in front of the motor container 3a. To the chuck sleeve 4, a driven tool 300 is detachably attached. Examples of the driven tool 300 may include a driver bit, a socket bit and/or a drill bit.

The housing 3 includes a trigger 5. The trigger 5 is located at the upper front of the grip 3b. The trigger 5 is manually operated (or manually moved, or pulled) by the user. The trigger 5 of this embodiment is displaced in response to manual operation. Specifically, the trigger 5 is in an initial position when the trigger 5 is not manually operated. When the trigger 5 is manually operated, the trigger 5 is displaced (i.e., moved) from the initial position. The electric work machine 1 can be driven by the manually operation of the trigger 5. The user can operate the trigger 5 with the user's finger while holding the grip 3b. The manual operation of the trigger 5 may include, for example, pulling the trigger 5, moving the trigger 5, and/or pushing the trigger 5.

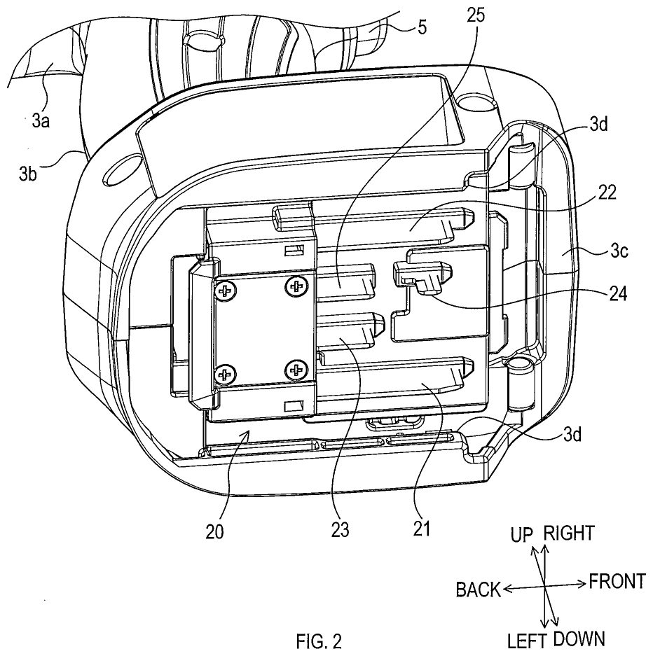

The housing 3 includes a battery port 3c. The battery port 3c is located at the lower end of the grip 3b. To the battery port 3c, the battery pack 10 is detachably attached. As shown in FIG. 2, the battery port 3c includes two rails 3d. The two rails 3d are mechanically coupled to the battery pack 10. The two rails 3d extend in a front-to-back direction. The battery pack 10 includes two insertion members (not shown). The two insertion members are inserted into the two rails 3d, respectively. The two insertion members are also extend in the front-to-back direction. The two insertion members are (i) inserted into the two rails 3d from the front and (ii) slid backward, thereby mechanically coupling the two insertion members to the two rails 3d. This allows the battery pack 10 to be attached to the battery port 3c.

The housing 3 includes a forward/reverse changeover switch 6. The forward/reverse changeover switch 6 is located in the upper end of the grip 3b. The forward/reverse changeover switch 6 is operated by the user. In response to the operation of the forward/reverse changeover switch 6, a rotation direction of the chuck sleeve 4 is switched in a forward or reverse direction. The forward direction corresponds to a direction in which screws, bolts, and the like can be tightened. The reverse direction corresponds to a direction in which a screw, a bolt, and the like can be loosened.

The housing 3 includes an operation panel 7. The operation panel 7 is installed in the battery port 3c. The operation panel 7 includes an operation button and/or a display.

As shown in FIG. 2, the work machine body 2 includes a terminal block 20. The terminal block 20 is located at the lower end of the battery port 3c. When the battery pack 10 is not attached to the work machine body 2, the terminal block 20 is exposed to the outside of the work machine body 2. When the battery pack 10 is attached to the work machine body 2, the terminal block 20 is covered (closed) by the battery pack 10 and is not visible from the outside.

The terminal block 20 includes a machine positive electrode terminal 21 and a machine negative electrode terminal 22. The terminal block 20 includes one or more machine auxiliary terminals. By way of example only, in this first embodiment, the one or more machine auxiliary terminals include a first machine signal terminal 23, a machine communication terminal 24, and a second machine signal terminal 25. The second machine signal terminal 25 receives permission information (i.e., a discharge permission signal) from the battery pack 10. Thus, the second machine signal terminal 25 may be referred to as an information input terminal. The machine positive electrode terminal 21, the machine negative electrode terminal 22, the first machine signal terminal 23, the machine communication terminal 24, and the second machine signal terminal 25 are electrically coupled to the battery pack 10 when the battery pack 10 is attached to the work machine body 2 (see FIG. 10).

When the battery pack 10 attached to the work machine body 2 is slid forward, the battery pack 10 is detached from the work machine body 2.

As shown in FIG. 1, the electric work machine 1 can wirelessly communicate with an external system 150. The external system 150 includes a manufacturer-side system 151 and an unlock system 152. The manufacturer-side system 151 may be owned by, for example, a manufacturer of the electric work machine 1 or its affiliates. The unlock system 152 may be installed, for example, in a retail store of the electric work machine 1. Specifically, the unlock system 152 may be installed in or near a checkout counter of the retail store. The checkout counter includes a register that accepts payment (i.e., settlement). The unlock system 152 may be coupled to or built in the register. The unlock system 152 may include a built-in register.

### (2-1-2) Configuration of Terminal Block

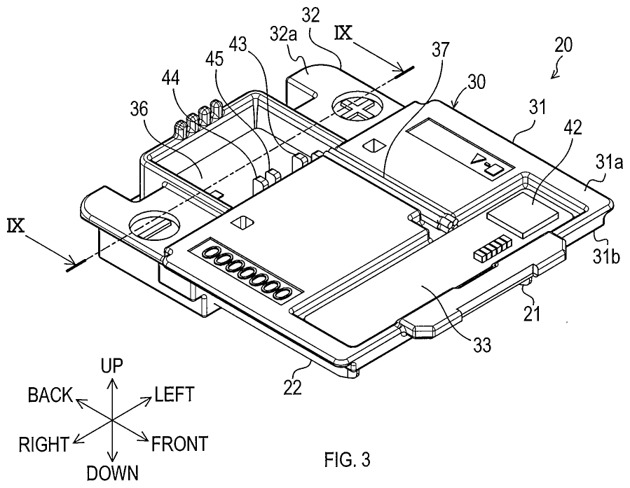

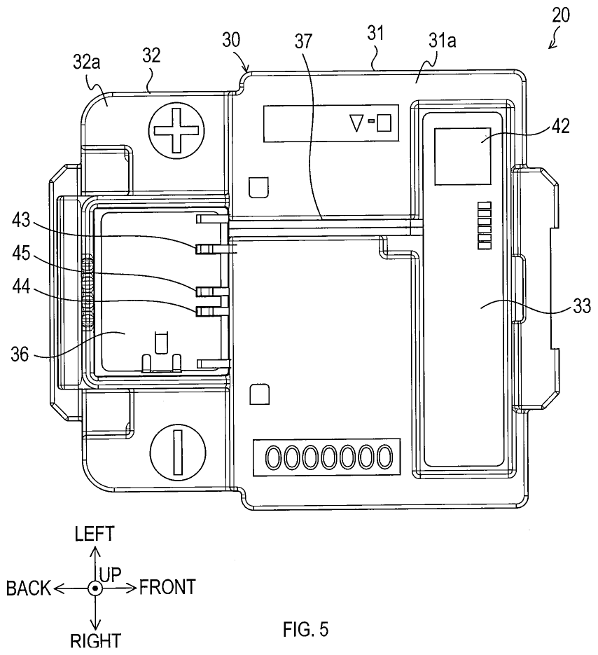

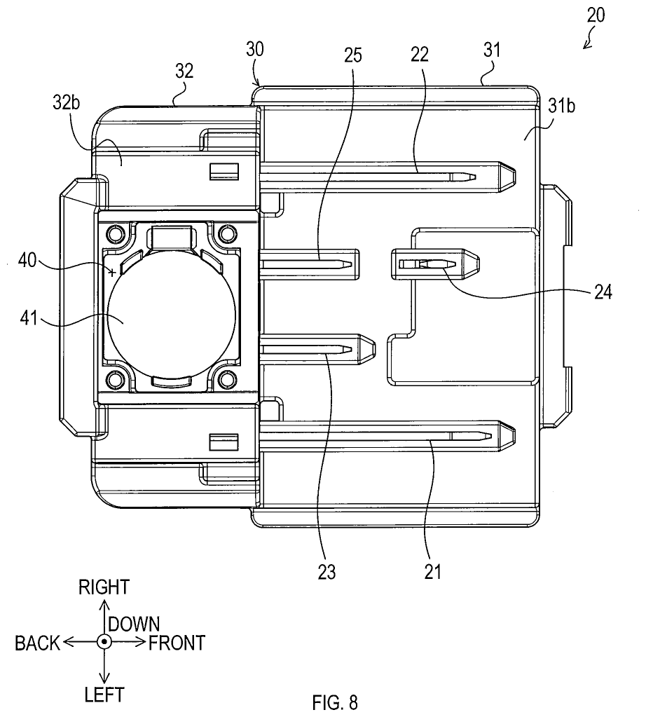

With reference to FIGS. 3 through 9, a configuration of the terminal block 20 is described in detail.

The terminal block 20 includes a holding body 30. The holding body 30 holds each part of the terminal block 20. The machine positive electrode terminal 21, the machine negative electrode terminal 22, the first machine signal terminal 23, the machine communication terminal 24, and the second machine signal terminal 25 are supported or fixed at defined positions by the holding body 30. The holding body 30 of the first embodiment is integrally formed by an electrical insulating material including resin.

The holding body 30 includes an upper surface (or a front side) and a lower surface (or a back side). The upper surface includes a first surface 31a and a first surface 32a as described below. The lower surface includes a second surface 31b and a second surface 32b as described below. The upper surface faces an internal space of the work machine body 2. Thus, it is impossible or difficult for the user to see the upper surface from the outside of the work machine body 2. The lower surface faces the battery pack 10. When the battery pack 10 is not attached to the work machine body 2, the user can see the lower surface from the outside of the work machine body 2. When the battery pack 10 is attached to the work machine body 2, the lower surface is blocked by the battery pack 10. In this case, the user cannot see the lower surface from the outside of the electric work machine 1.

The holding body 30 includes a first holder 31 and a second holder 32. The first holder 31 corresponds to the first half of the entire holding body 30. The second holder 32 corresponds to (i) the latter half of the entire holding body 30 and (ii) a portion other than the first holder 31.

The first holder 31 has a shape of a substantially rectangular flat plate. The first holder 31 includes the first surface 31a and the second surface (or terminal arrangement area) 31b. The first surface 31a and the second surface 31b are in a front-to-back relationship with each other. The first surface 31a corresponds to a part of the upper surface. The second surface 31b corresponds to a part of the lower surface.

The second holder 32 has a substantially rectangular parallelepiped shape. The second holder 32 includes the first surface 32a and the second surface (or holder arrangement area) 32b. The first surface 32a and the second surface 32b are in a front-to-back relationship with each other. The first surface 32a corresponds to a part of the upper surface. The second surface 32b corresponds to a part of the lower surface.

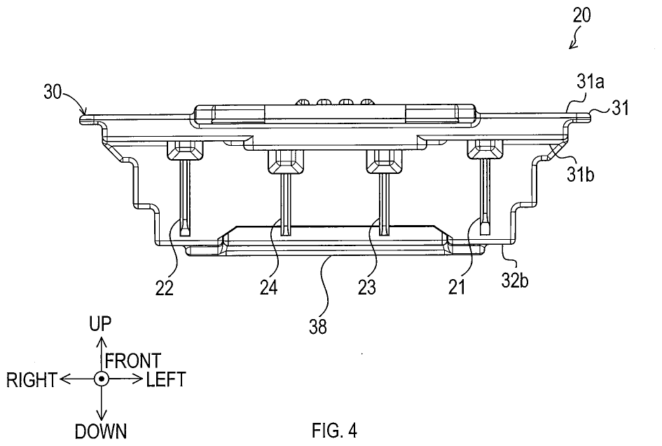

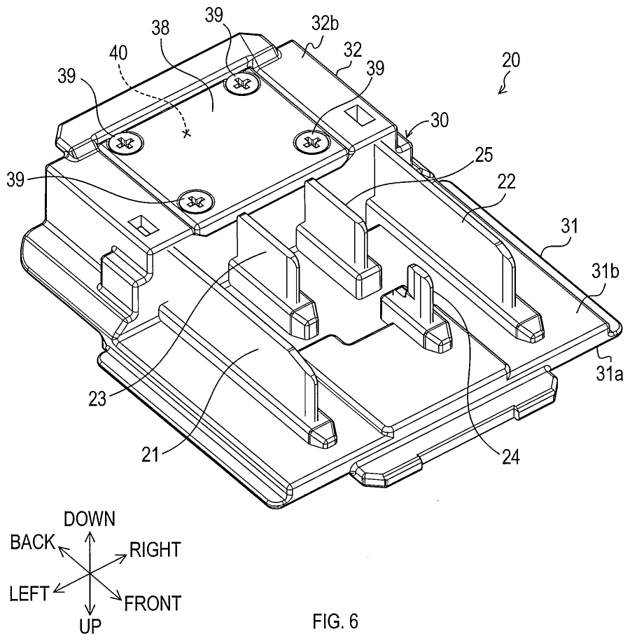

Most part of each of the machine positive electrode terminal 21, the machine negative electrode terminal 22, the first machine signal terminal 23, the machine communication terminal 24, and the second machine signal terminal 25 (including a front end and a portion to be in contact with the battery pack 10) is fixed on the second surface 31b of the first holder 31 (see FIGS. 4, 6, etc.).

Almost all (or all) portion of each rear end of the machine positive electrode terminal 21, the machine negative electrode terminal 22, the first machine signal terminal 23, the machine communication terminal 24, and the second machine signal terminal 25 is located within the second holder 32.

The terminal block 20 includes a main board (or main circuit board) 33. The main board 33 is arranged on the first surface 31a of the first holder 31 in this first embodiment. More specifically, the main board 33 is arranged on a front end side of the first surface 31a. The front end area of the first surface 31a includes a recess. The main board 33 is arranged in the recess.

The terminal block 20 includes a wireless communicator 42. The wireless communicator 42 is mounted on the main board 33. The wireless communicator 42 can wirelessly communicate with the external system 150 according to a specific wireless communication protocol (or a specific wireless communication method).

The specific wireless communication protocol may be any method. For example, the specific wireless communication protocol of this first embodiment follows the Bluetooth Low Energy (hereinafter referred to as “BLE”) communication standard. “Bluetooth” is a registered trademark. Hereinafter, “wireless communication” means wireless communication in accordance with BLE unless otherwise specified.

The terminal block 20 includes a relay board 36 and a relay wiring group 37. The relay board 36 is arranged on the first surface 32a of the second holder 32 in this first embodiment. More specifically, the relay board 36 is arranged at an approximate center of the first surface 32a in the left-right direction. The first surface 32a includes a recess at the approximate center. The relay board 36 is arranged in the recess.

The relay board 36 is configured to relay electrical connections between the battery pack 10 and the main board 33, and between the work machine body 2 and the main board 33. The relay wiring group 37 electrically couples the relay board 36 to the main board 33. The main board 33 is electrically coupled to the battery pack 10 and the work machine body 2 through the relay wiring group 37 and the relay board 36.

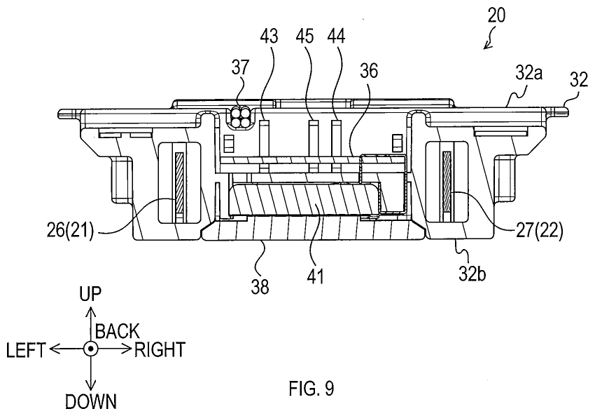

As shown in FIG. 9, the terminal block 20 includes a first relay terminal (or a first terminal block relay terminal) 26 and a second relay terminal (or a second terminal block relay terminal) 27. The first relay terminal 26 is electrically coupled to the machine positive electrode terminal 21. The first relay terminal 26 may be a part (e.g., a rear end) of the machine positive electrode terminal 21. The first relay terminal 26 is coupled to a sixth relay terminal 51 (see FIG. 10) of the work machine body 2 as described below. The second relay terminal 27 is electrically coupled to the machine negative electrode terminal 22. The second relay terminal 27 may be a part (e.g., a rear end) of the machine negative electrode terminal 22. The second relay terminal 27 is coupled to a seventh relay terminal 52 (see FIG. 10) of the work machine body 2 as described below.

As shown in FIGS. 3, 5, and 9, the terminal block 20 includes two or more relay terminals. This is only an example, but the two or more relay terminals of the first embodiment include a third relay terminal (or a third terminal block relay terminal) 43 and a fourth relay terminal (or a fourth terminal block relay terminal) 44 and a fifth relay terminal (or a fifth terminal block relay terminal) 45. The third relay terminal 43 is electrically coupled to the first machine signal terminal 23 through the relay board 36. The third relay terminal 43 may be a part (e.g., a rear end) of the first machine signal terminal 23. The fourth relay terminal 44 is electrically coupled to the machine communication terminal 24 through the relay board 36. The fourth relay terminal 44 may be a part (e.g., a rear end) of the machine communication terminal 24. The fifth relay terminal 45 is electrically coupled to the second machine signal terminal 25 through the relay board 36 and the main board 33.

The second surface 32b of the second holder 32 is described with reference to FIGS. 6 through 9. The second surface 32b includes a battery holder 40. The battery holder 40 includes an opening that is open downwardly. The battery holder 40 has a space in a substantially rectangular parallelepiped shape.

The opening is closed by a cover 38. The cover 38 is removable from the opening. The cover 38 is fastened to the second surface 32b by four screws 39 in this first embodiment. The cover 38 may be attached to and detached from the opening in any manner. The cover 38 may be attached by a method other than a method using the four screws 39. For example, the cover 38 may be attached to the opening by one through three, or five or more screws. The cover 38 may be attached to the opening without using a screw.

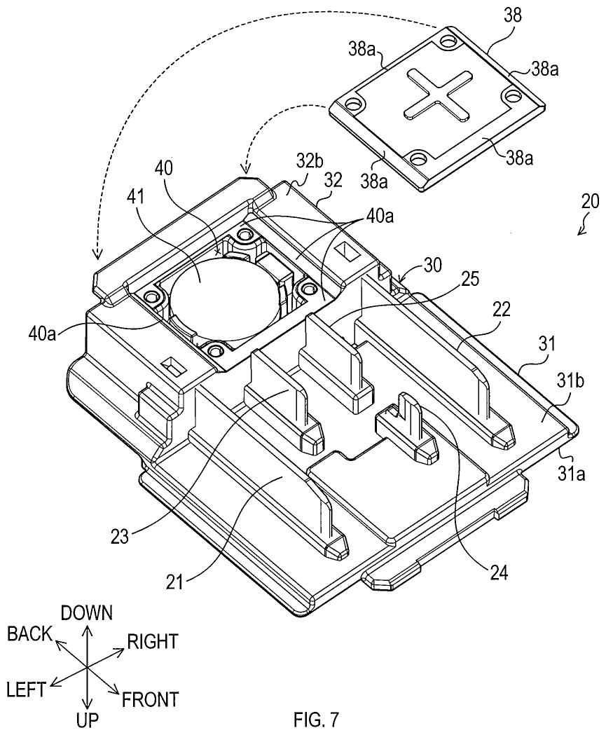

As shown in FIG. 7, the cover 38 is provided with a sealing member 38a in an area facing the battery holder 40. Specifically, the sealing member 38a in this first embodiment is arranged on and/or near the outer periphery of the cover 38 in an encircling manner. The cover 38 includes four first screw holes. The four first screw holes penetrate through the sealing member 38a. The four screws 39 penetrate through the four first screw holes, respectively.

The terminal block 20 includes a cover receiving surface 40a. The cover receiving surface 40a faces the sealing member 38a when the opening is covered by the cover 38. In this first embodiment, the cover receiving surface 40a is arranged on the opening in an encircling manner. The cover receiving surface 40a includes four second screw holes. The four screws 39 are screwed into the four second screw holes, respectively.

When the cover 38 is attached to the battery holder 40 by the four screws 39, the sealing member 38a is in close contact with the cover receiving surface 40a. This causes the battery holder 40 to be sealed by the cover 38 and the sealing member 38a. Even when the cover 38 is attached by a method other than the method using the four screws 39, the battery holder 40 is also sealed by the cover 38 and the sealing member 38a in response to the cover 38 being attached.

The sealing member 38a may contain any material. For example, the sealing member 38a may include rubber as a main component.

The sealing member 38a may be provided to the cover 38 in any manner. For example, the sealing member 38a may be adhered to the cover 38 by an adhesive. For example, the sealing member 38a may be formed by two-color molding. The two-color molding is also called double molding. The two-color molding is a molding method in which two different types of components (e.g. both resins) are combined and molded into a single piece.

The sealing member 38a may be provided on the terminal block 20. Specifically, the sealing member 38a may be provided to the cover receiving surface 40a in an encircling manner.

The battery holder 40 detachably holds a second battery 41. The second battery 41 has a rated voltage of, for example, 3 V. The second battery 41 supplies a second electric power to the wireless communicator 42. The wireless communicator 42 operates by receiving the second electric power from the second battery 41. The second battery 41 may be any form of battery. The second battery 41 may be a non-rechargeable battery that cannot be recharged repeatedly or a rechargeable battery that can be recharged repeatedly. In this first embodiment, the second battery 41 is a non-rechargeable battery. More specifically, the second battery 41 is in the form of a button cell battery.

### (2-1-3) Electrical Configuration of Electric Work Machine

With reference to FIG. 10, an electrical configuration of the electric work machine 1 is described in detail. As described above, the electric work machine 1 includes the work machine body 2 and the battery pack 10. The work machine body 2 includes the terminal block 20. FIG. 10 shows a state in which the battery pack 10 is attached to the work machine body 2.

The battery pack 10 includes the above-described first battery 16 and a battery management unit (hereinafter, also referred to as “BMU”) 17. The first battery 16 includes two or more cells coupled in series to each other. The BMU 17 monitors various states of the battery pack 10. The various states include the voltage of the first battery 16, the voltage of each of the two or more cells, the temperature of the first battery 16, the discharge current from the first battery 16, the charging current to the first battery 16, and/or the temperature of the BMU 17. The BMU 17 determines permission/prohibition of discharging, permission/prohibition of charging, and the like based on the monitoring result. The BMU 17 also performs (i) transmission and reception of various signals and/or (ii) a data communication, between the BMU 17 and the work machine body 2.

The battery pack 10 includes a positive electrode connection terminal 11 and a negative electrode connection terminal 12. The battery pack 10 includes one or more battery auxiliary terminals. In this first embodiment, the one or more battery auxiliary terminals include a first battery signal terminal 13, a battery communication terminal 14, and a second battery signal terminal 15. The positive electrode connection terminal 11 is coupled to a positive electrode of the first battery 16. The negative electrode connection terminal 12 is coupled to a negative electrode of the first battery 16. The first battery signal terminal 13, the battery communication terminal 14, and the second battery signal terminal 15 are coupled to the BMU 17.

The BMU 17 receives a start signal and/or a connection signal from the work machine body 2 through the first battery signal terminal 13. The start signal indicates whether the trigger 5 is manually operated (i.e., whether the trigger 5 is displaced from the initial position). The BMU 17 can recognize that the battery pack 10 is attached to the work machine body 2 based on the connection signal being received. The BMU 17 can recognize that the trigger 5 is displaced based on the start signal being received.

The BMU 17 can perform a data communication with the work machine body 2 (more specifically, with the work machine controller 53 as described below) through the battery communication terminal 14. The data communication is, for example, in the form of a serial communication in this first embodiment.

The BMU 17 outputs, based on the above-described monitoring result, a charge permission signal or a charge prohibition signal to a work machine controller 53 (hereinafter, simply referred to as “controller 53”) through the second battery signal terminal 15. When the BMU 17 determines that the battery pack 10 is in a dischargeable state, the BMU 17 outputs a discharge permission signal (or permission information). The dischargeable state corresponds to a state the first battery 16 can properly discharge the first electric power to the work machine body 2. The discharge permission signal allows the controller 53 to drive the electric load 50. When the BMU 17 determines that the battery pack 10 is in a non-dischargeable state, the BMU 17 outputs the discharge prohibition signal. The non-dischargeable state corresponds to a state in which the first battery 16 should not discharge the first electric power to the work machine body 2 (e.g., a faulty, failure, defect, or improper state). The discharge prohibition signal instructs the controller 53 not to drive the electric load 50. Examples of the non-dischargeable state may include an over-discharged state and/or an overheated state. The over-discharged state corresponds to a state in which the remaining energy of the first battery 16 is less than a prescribed lower limit. The overheated state corresponds to a state in which the temperature of the first battery 16 is higher than a prescribed upper temperature limit.

The work machine body 2 includes the electric load 50, the controller 53, and the trigger 5. The electric load 50 of the first embodiment includes a motor. Therefore, the electric load 50 is hereinafter referred to as “motor 50”.

The controller 53 includes a first microcomputer. The first microcomputer includes a first CPU and a first semiconductor memory. The first semiconductor memory includes a ROM, a RAM, and a rewritable nonvolatile memory. Examples of the rewritable nonvolatile memory include an EEPROM, a flash memory, a ReRAM, and a FeRAM. Various functions of the controller 53 are achieved by the first CPU executing a first program stored in the first semiconductor memory. When the first CPU executes this first program, a method corresponding to this first program is executed.

In another embodiment, the controller 53 may include an additional microcomputer. In still another embodiment, some or all of the functions to be achieved by the first CPU may be achieved with one or more electronic components (e.g., integrated circuit). In still another embodiment, the controller 53 may be a logic circuit (or a wired logic connection) including two or more electronic components. In still another embodiment, the controller 53 may include an Application Specific Integrated Circuit (ASIC) and/or an Application Specific Standard Product (ASSP). In still another embodiment, the controller 53 may include a programmable logic device from which a reconfigurable logic circuit can be constructed. Examples of the programmable logic device includes an FPGA.

The BMU 17 includes a second microcomputer. The second microcomputer includes a second CPU and a second semiconductor memory like the first microcomputer. The second semiconductor memory includes one or more of various forms of memory like the first semiconductor memory. Various functions of the BMU 17 are achieved by the second CPU executing a second program stored in the second semiconductor memory. When the second CPU executes this second program, a method corresponding to this second program is executed. The configurations of the controller 53, as described in the above-described “another embodiment” are also applied to the BMU 17.

The motor 50 receives a driving power from the controller 53 to thereby be driven. The motor 50 of the first embodiment is in the form of a three-phase brushless motor. However, the motor 50 may be in a form different from the three-phase brushless motor. The rotation of the motor 50 is transmitted to the chuck sleeve 4 through a transmission mechanism, which is not shown. When the motor 50 rotates, a driven tool 300 attached to the chuck sleeve 4 rotates together with the chuck sleeve 4. This allows various types of work to be done by the driven tool 300.

The work machine body 2 includes the sixth relay terminal (or a first internal relay terminal) 51, the seventh relay terminal (or a second internal relay terminal) 52, an eighth relay terminal (or a third internal relay terminal) 55, a ninth relay terminal (or a fourth internal relay terminal) 56, and a tenth relay terminal (or a fifth internal relay terminal) 57. The sixth relay terminal 51, the seventh relay terminal 52, the eighth relay terminal 55, the ninth relay terminal 56, and the tenth relay terminal 57 are coupled to the controller 53.

The sixth relay terminal 51 is coupled to the first relay terminal 26. The sixth relay terminal 51 may be detachably coupled to the first relay terminal 26. The sixth relay terminal 51 is electrically coupled to the positive electrode connection terminal 11 of the battery pack 10 through the first relay terminal 26.

The seventh relay terminal 52 is coupled to the second relay terminal 27. The seventh relay terminal 52 may be detachably coupled to the second relay terminal 27. The seventh relay terminal 52 is electrically coupled to the negative electrode connection terminal 12 of the battery pack 10 through the second relay terminal 27.

The eighth relay terminal 55 is coupled to the third relay terminal 43. The eighth relay terminal 55 may be detachably coupled to the third relay terminal 43. The eighth relay terminal 55 is electrically coupled to the first battery signal terminal 13 of the battery pack 10 through the third relay terminal 43.

The ninth relay terminal 56 is coupled to the fourth relay terminal 44. The ninth relay terminal 56 may be detachably coupled to the fourth relay terminal 44. The ninth relay terminal 56 is electrically coupled to the battery communication terminal 14 of the battery pack 10 through the fourth relay terminal 44.

The tenth relay terminal 57 is coupled to the fifth relay terminal 45. The tenth relay terminal 57 may be detachably coupled to the fifth relay terminal 45. The tenth relay terminal 57 is electrically coupled to the second battery signal terminal 15 of the battery pack 10 through the fifth relay terminal 45. More specifically, in this first embodiment, a switching circuit 46 is provided between the fifth relay terminal 45 and the second machine signal terminal 25. Therefore, the tenth relay terminal 57 is electrically coupled to the second battery signal terminal 15 through the fifth relay terminal 45, the switching circuit 46, and the second machine signal terminal 25. The switching circuit 46 is mounted on the main board 33. The switching circuit 46 may be mounted on the relay board 36.

In this configuration, the controller 53 receives the first electric power from the first battery 16 through the sixth relay terminal 51 and the seventh relay terminal 52. The controller 53 converts the first electric power into the driving power. The controller 53 delivers the driving power to the motor 50, thereby driving the motor 50.

The controller 53 drives the motor 50 when (i) the controller 53 has received the discharge permission signal from the battery pack 10 and (ii) the trigger 5 is displaced from the initial position. The controller 53 does not drive the motor 50 when (i) the controller 53 has not received the discharge permission signal from the battery pack 10, (ii) the controller 53 has received the discharge prohibition signal from the battery pack 10, or (iii) the trigger 5 is in the initial position.

Then, an electrical configuration of the terminal block 20 is described. The terminal block 20 includes a board section 20a. The board section 20a includes the above-described main board 33 and the relay board 36. That is, in FIG. 10, the main board 33 and the relay board 36 are collectively referred to and illustrated as the board section 20a to simplify the explanation.

The board section 20a includes a first signal path 23a. The first signal path 23a electrically couples the first machine signal terminal 23 to the third relay terminal 43.

The board section 20a includes a communication path 24a. The communication path 24a electrically couples the machine communication terminal 24 to the fourth relay terminal 44. In this embodiment, (i) most or all of the first signal path 23a, and/or (ii) most or all of the communication path 24a are arranged on the relay board 36. The first signal path 23a and/or the communication path 24a may be arranged on the main board 33 and the relay board 36.

The board section 20a includes a second signal path 25a. The second signal path 25a electrically couples the second machine signal terminal 25 to the fifth relay terminal 45. The relay wiring group 37 includes a part of the second signal path 25a. In addition, the main board 33 includes another part of the second signal path 25a. That is, the second signal path 25a extends from the relay board 36 through the relay wiring group 37 to the main board 33. The second signal path 25a transmits, to the controller 53, permission information (i.e., a charge permission signal) input from the battery pack 10, as described below. Therefore, the second signal path 25a may be referred to as an information transmission path.

The second signal path 25a includes the switching circuit 46 provided thereon. The switching circuit 46 completes or interrupts the second signal path 25a. The switching circuit 46 includes a first end coupled to the second machine signal terminal 25. The switching circuit 46 includes a second end coupled to the fifth relay terminal 45.

More specifically, the switching circuit 46 in this first embodiment includes a first switch 47 on the second signal path 25a. The first switch 47 completes or interrupts the second signal path 25a. The first switch 47 includes a first end electrically corresponding to the first end of the switching circuit 46, and a second end electrically corresponding to the second end of the switching circuit 46.

The first switch 47 may be in any form. For example, in this first embodiment, the first switch 47 may be in the form of a semiconductor switching element. More specifically, the first switch 47 may be in the form of a metal-oxide-semiconductor field effect transistor (MOSFET), for example.

The terminal block 20 includes the wireless communicator 42. The wireless communicator 42 includes an antenna 42a. The wireless communicator 42 communicates wirelessly with the external system 150 through the antenna 42a. The wireless communicator 42 operates by receiving the second electric power from the second battery 41.

The wireless communicator 42 and the switching circuit 46 are provided to electronically lock and unlock the electric work machine 1.

In this first embodiment, the electric work machine 1 is electronically locked before the electric work machine 1 is sold at a retail store. The manufacturer-side system 151 electronically locks the electric work machine 1 through the wireless communicator 42.

“Electronic locking” (or activating an electronic lock) means that the electric work machine 1 is set so that the motor 50 is not driven even if the trigger 5 is manually operated. The electronic locking in this first embodiment includes turning off the switching circuit 46, thereby interrupting the second signal path 25a. When the second signal path 25a is interrupted, the discharge permission signal from the battery pack 10 is not input to the controller 53. When the electric work machine 1 is electronically locked, the electric work machine 1 is forcibly set to an inoperable state. The inoperable state corresponds to a state in which the motor 50 cannot operate. Therefore, while the electronic lock is activated (or actuated), the motor 50 is not driven even if the trigger 5 is manually operated.

The electronic lock is unlocked when the electric work machine 1 is purchased (e.g., after payment) by a customer at a retail store. Specifically, the electronic lock is unlocked by the unlock system 152 in the retail store.

The unlock system 152 wirelessly transmits an unlock signal to the wireless communicator 42, thereby unlocking the electronic lock. The wireless communicator 42 turns on the switching circuit 46 based on the unlock signal being received. This causes the second signal path 25a to be completed, and the electronic lock is unlocked.

### (2-1-4) Electronic Locking and Unlocking

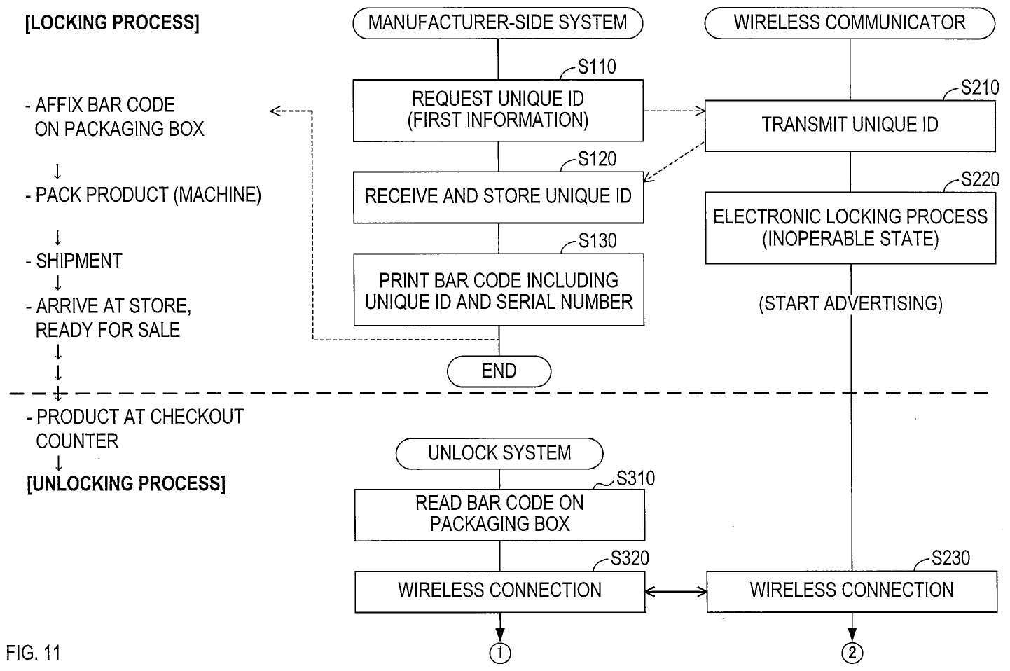

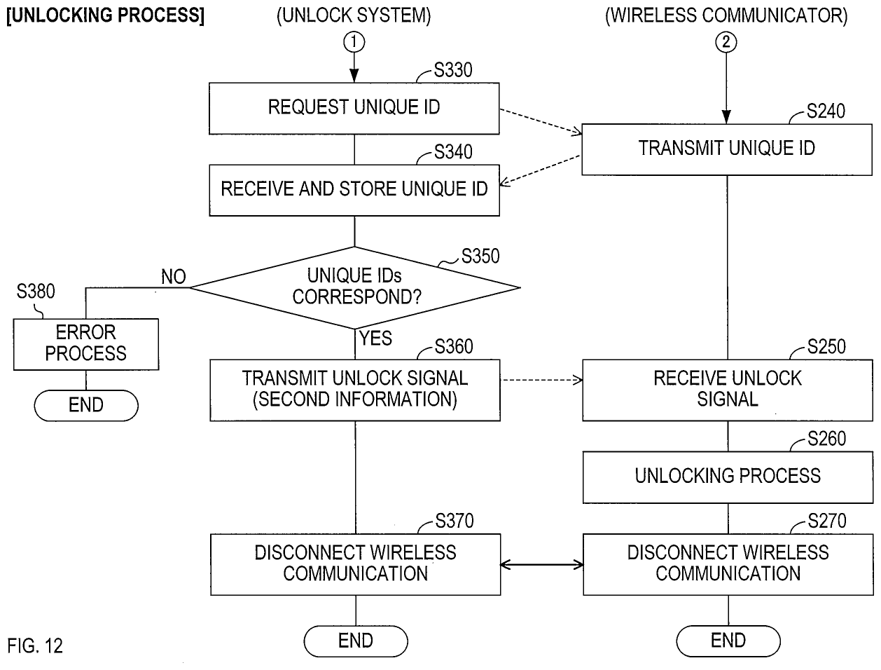

Next, an example of a flowchart illustrating the steps of electronic locking and subsequent unlocking is described with reference to FIGS. 11 and 12 focusing mainly on the control of the first switch 47 by the wireless communicator 42. The electric work machine 1 of this first embodiment is shipped with the battery pack 10 attached to the work machine body 2. However, the work machine body 2 may be shipped as a single unit.

As shown in FIG. 11, a locking process is performed to electronically lock the electric work machine 1 prior to shipment. Specifically, the manufacturer-side system 151 requires the wireless communicator 42 to transmit a unique ID via wireless communication (S110). The unique ID is a unique identifier possessed (e.g., stored) by the wireless communicator 42. The unique ID may be in the form of a so-called universally unique identifier (UUID). S110 may include transmitting first information indicating the request for the unique ID.

In this first embodiment, requesting the wireless communicator 42 that has not undergone an electronic locking process (S220) to transmit the unique ID (i.e., transmitting the first information) includes requesting an electronic locking. Note that the manufacturer-side system 151 may request the electronic locking separately from the request for the unique ID. For example, the manufacturer-side system 151 may transmit the first information including a lock command, thereby requesting the electronic locking.

The wireless communicator 42 transmits the unique ID to the manufacturer-side system 151 via wireless communication based on the manufacturer-side system 151 requesting the unique ID (S210).

The manufacturer-side system 151 receives the unique ID transmitted from the wireless communicator 42 and stores the unique ID (S120). The manufacturer-side system 151 prints a bar code on a medium (S130). The bar code includes the unique ID and a product serial number (hereinafter, referred to as “serial number”). The medium may be a sticker with an adhesive, for example. The serial number is a number assigned to the electric work machine 1 for management purposes.

The medium with the bar code printed thereon is affixed to a packaging box by a worker. The electric work machine 1 is packed in the packaging box and shipped. At this time, the unique ID shown by the bar code affixed to the packaging box is the same as the unique ID possessed by the wireless communicator 42 of the electric work machine 1 in the packaging box. The shipped electric work machine 1 arrives at a retail store, and is ready for sale.

Meanwhile, in response to the request for the unique ID having received (i.e., in response to having received the request for the electronic locking), the wireless communicator 42 performs the electronic locking process (S220). Specifically, the wireless communicator 42 turns off the first switch 47, thereby electronically locking the electric work machine 1. This interrupts the second signal path 25a, and prevents the discharge permission signal from being input to the controller 53.

In this first embodiment, the wireless communication is performed according to the BLE wireless communication standard. Therefore, the wireless communicator 42 starts advertising after the electronic locking process is performed. The wireless communicator 42 may also advertise before the execution of the process of S210. The manufacturer-side system 151 may request the unique ID after a wireless connection with the wireless communicator 42 is established. The manufacturer-side system 151 may (i) scan an advertising packet from the wireless communicator 42, and (ii) establish the wireless connection with the wireless communicator 42 upon receiving the advertising packet as a starting point.

At the retail store, a customer wishing to purchase the electric work machine 1 brings the electric work machine 1 (or, more specifically, the packaging box containing the electric work machine 1) to a checkout counter. In response to the customer's payment, an unlocking process is initiated.

Specifically, a staff at the checkout counter operates the unlock system 152 and causes the unlock system 152 to read the bar code affixed to the packaging box (S310). As a result, the serial number and the unique ID included in the bar code are obtained by the unlock system 152.

After reading the bar code, the unlock system 152 performs a first process to establish a wireless connection with the wireless communicator 42 (S320). The first process includes a communication with the wireless communicator 42. At this time, the wireless communicator 42 also performs a second process necessary for the wireless connection in accordance with the request and the like from the unlock system 152 (S230). The second process includes a communication with the unlock system 152. As a result, a wireless connection is established between the unlock system 152 and the wireless communicator 42 (S320, S230).

As shown in FIG. 12, once the wireless connection is established, the unlock system 152 requests the wireless communicator 42 for the unique ID via wireless communication (S330). In response to the request from the unlock system 152 to transmit the unique ID, the wireless communicator 42 transmits the unique ID stored in the wireless communicator 42 to the unlock system 152 via wireless communication (S240).

The unlock system 152 receives and stores the unique ID transmitted from the wireless communicator 42 (S340). The unlock system 152 determines whether the stored unique ID corresponds to the unique ID read from the bar code (S350). If the stored unique ID does not correspond to the unique ID of the bar code, the unlock system 152 performs an error process (S380). In response to the error process being performed, the unlock system 152 terminates the process related to the electronic locking. The error process may include, for example, informing the staff that the unique IDs do not correspond to each other (and thus the electronic lock cannot be unlocked).

If the stored unique ID corresponds to the unique ID of the bar code, the unlock system 152 transmits second information (specifically, an unlock signal) to the wireless communicator 42 via wireless communication (S360).

Upon receiving the unlock signal from the unlock system 152 (S250), the wireless communicator 42 performs an unlocking process (S260). Specifically, the wireless communicator 42 turns on the first switch 47, thereby unlocking the electronic lock. Once the electronic lock is unlocked, the inoperable state is cancelled. Specifically, the second signal path 25a is completed, thereby allowing the discharge permission signal to be input to the controller 53.

After transmitting the unlock signal, the unlock system 152 disconnects the wireless connection from the wireless communicator 42 (S370). This also causes the wireless communicator 42 to disconnect the wireless connection from the unlock system 152 (S270).

### (2-1-5) Correspondence Between Terms

The work machine body 2 is an example of the battery-powered device in the overview of embodiments. The controller 53 corresponds to an example of the controller in the overview of embodiments. The motor 50 corresponds to the example of an electric load in the overview of embodiments. The machine positive electrode terminal 21, the machine negative electrode terminal 22, the first machine signal terminal 23, the machine communication terminal 24, and the second machine signal terminal 25 correspond to examples of the two or more machine-side terminals in the overview of embodiments. The positive electrode connection terminal 11, the negative electrode connection terminal 12, the first battery signal terminal 13, the battery communication terminal 14, and the second battery signal terminal 15 correspond to examples of the two or more battery-side terminals in the overview of embodiments. The second surface 31b of the first holder 31 corresponds to an example of the terminal arrangement area in the overview of embodiments. The electronically locked state corresponds to an example of the inoperable state in the overview of embodiments. The request for the unique ID from the manufacturer-side system 151 (S110) corresponds to an example of the first information in the overview of embodiments. The unlock signal from the unlock system 152 corresponds to an example of the second information in the overview of embodiments. The second machine signal terminal 25 or the machine communication terminal 24 corresponds to an example of the information input terminal in the overview of embodiments. The discharge permission signal corresponds to an example of the permission information in the overview of embodiments. The second signal path 25a or the communication path 24a corresponds to an example of the information transmission path in the overview of embodiments.

### 2-2. Second Embodiment

(2-2-1) Summary of Differences from First Embodiment

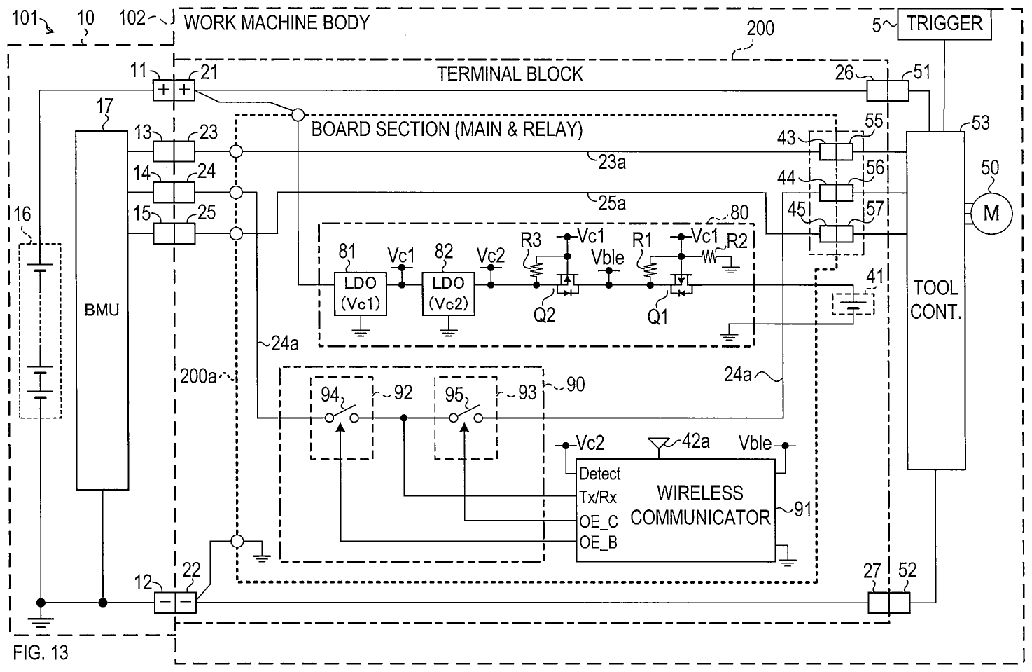

As shown in FIG. 13, in an electric work machine 101 of a second embodiment, the structure and functions of the terminal block 200 are partially different from the terminal block 20 of the first embodiment. Except for the terminal block 200, the electric work machine 101 of the second embodiment is basically configured in the same way as the electric work machine 1 of the first embodiment. In FIG. 13, the main board 33 and the relay board 36 are shown together as a board section 200a to simplify the explanation.

The terminal block 200 of the second embodiment is almost the same in appearance as the terminal block 20 of the first embodiment.

The terminal block 200 of the second embodiment is different from the terminal block 20 of the first embodiment basically in (i) the circuit configuration in the main board 33 and (ii) the fact that the machine positive electrode terminal 21 is electrically coupled to the main board 33.

Also, in this second embodiment, the function of a wireless communicator 91 is partially different from the function of the wireless communicator 42 of the first embodiment. The wireless communicator 91 of this second embodiment includes a function to perform a data communication with the work machine body 102 and/or the battery pack 10. Specifically, the data communication with the work machine body 102 includes communication with the controller 53, and the data communication with the battery pack 10 includes communication with the BMU 17.

In addition, the second embodiment is different from the first embodiment in the electronic locking method. In this second embodiment, as described below, the wireless communicator 91 requests the controller 53 and/or the BMU 17, by data communication, to perform the electronic locking. That is, the controller 53 and/or the BMU 17 perform the electronic locking.

The configurations and functions, etc., different from the first embodiment are described below.

### (2-2-2) Electrical Configuration of Terminal Block

As shown in FIG. 13, in this second embodiment, the fourth relay terminal 44 is electrically coupled to the machine communication terminal 24 through the relay board 36 and the main board 33. The fifth relay terminal 45 is electrically coupled to the second machine signal terminal 25 through the relay board 36. The fifth relay terminal 45 may be a part (e.g., a rear end) of the second machine signal terminal 25.

The terminal block 200 includes a power switching circuit 80.

The power switching circuit 80 is coupled to the machine positive electrode terminal 21. When the battery pack 10 is attached to the work machine body 102, the first electric power of the first battery 16 is input to the power switching circuit 80 through the machine positive electrode terminal 21. The power switching circuit 80 generates a first control voltage Vc1 and a second control voltage Vc2 from the first electric power as described below. The second control voltage Vc2 is input to the wireless communicator 91.

The power switching circuit 80 receives the second electric power from the second battery 41. When the battery pack 10 is not attached to the work machine body 102, the power switching circuit 80 delivers the second electric power of the second battery 41 to the wireless communicator 91 as a power-supply voltage Vble. The wireless communicator 91 receives the power-supply voltage Vble and operates with the power-supply voltage Vble. When the battery pack 10 is attached to the work machine body 102, the power switching circuit 80 delivers the second control voltage Vc2 to the wireless communicator 91 as the power-supply voltage Vble.

The terminal block 200 includes a communication switching circuit 90. The communication switching circuit 90 is provided on the communication path 24a. The communication switching circuit 90 completes or interrupts the communication path 24a.

In this second embodiment, the second signal path 25a does not include a switching circuit.

The terminal block 200 includes the wireless communicator 91. In this second embodiment, the power switching circuit 80, the communication switching circuit 90, and the wireless communicator 91 are mounted on the main board 33.

The wireless communicator 91 is coupled to the communication switching circuit 90. The communication switching circuit 90 is controlled by the wireless communicator 91.

The wireless communicator 91 can perform a data communication with the controller 53 or the BMU 17 through the communication switching circuit 90. The controller 53 and the BMU 17 can perform a data communication with each other through the communication switching circuit 90.

The power switching circuit 80 is described in more detail. The power switching circuit 80 includes a first power supply circuit 81.

The first power supply circuit 81 receives a first battery voltage VB through the machine positive electrode terminal 21. The first battery voltage VB corresponds to a voltage of the first battery 16. The first power supply circuit 81 generates the first control voltage Vc1 from the first battery voltage VB. The first control voltage Vc1 is in the form of, for example, a direct current (DC) voltage having a voltage value of 5 V. In this second embodiment, the first control voltage Vc1 is higher than a second battery voltage V2. The second battery voltage V2 corresponds to a voltage of the second battery 41.

The power switching circuit 80 includes a second power supply circuit 82. The second power supply circuit 82 generates the second control voltage Vc2 from the first control voltage Vc1. The second control voltage Vc2 is lower than the first control voltage Vc1. The second control voltage Vc2 is in the form of, for example, a DC voltage having a voltage value of 3.3 V. In this second embodiment, the magnitude of the second control voltage Vc2 is equal to or close to the magnitude of the second battery voltage V2. For example, the magnitude of the second battery voltage V2 is 3 V. The power switching circuit 80 includes a first switching element Q1 and a second switching element Q2. The first switching element Q1 is in the form of a p-channel MOSFET in this second embodiment. The second switching element Q2 is in the form of an n-channel MOSFET in this second embodiment.

The first switching element Q1 includes a drain coupled to the positive electrode of the second battery 41. The first switching element Q1 includes a gate. The gate of the first switching element Q1 is coupled to a first control power-supply line, a first end of a first resistor R1 and a first end of a second resistor R2. The first power supply circuit 81 includes a first output terminal configured to output the first control voltage Vc1. The first control power-supply line is electrically coupled to the first output terminal. The first control power-supply line receives the first control voltage Vc1 from the first output terminal and delivers the first control voltage Vc1 to the first and second switching elements Q1, Q2, and the like. The first switching element Q1 includes a source coupled to a second end of the first resistor R1. A second end of the second resistor R2 is coupled to a ground line. In this second embodiment, a resistance value of the first resistor R1 is sufficiently higher than that of the second resistor R2. For example, the resistance value of the first resistor R1 may be 4.7 MΩ, and the resistance value of the second resistor R2 may be 1 MΩ.

The second switching element Q2 includes a gate. The gate of the second switching element Q2 is coupled to the first control power-supply line and a first end of a third resistor R3. The second switching element Q2 includes a drain coupled to the second end of the first resistor R1. The second switching element Q2 includes a source coupled to a second end of the third resistor R3 and a second control power-supply line. The second power supply circuit 82 includes a second output terminal configured to output the second control voltage Vc2. The second control power-supply line is electrically coupled to the second output terminal. The second control power-supply line receives the second control voltage Vc2 from the second output terminal and delivers the second control voltage Vc2 to the wireless communicator 91, and the like.

The second control power-supply line is electrically coupled to the wireless communicator 91. Thus, when the second control voltage Vc2 is generated, the wireless communicator 91 receives the second control voltage Vc2. The source of the first switching element Q1 and the drain of the second switching element Q2 is electrically coupled to the wireless communicator 91.

The operation of the power switching circuit 80 thus configured is different depending on whether the battery pack 10 is attached to the work machine body 102. The operation in each case is described below. In the following description, it is assumed that the second battery 41 is attached to the terminal block 200.

First, the operation of the power switching circuit 80 when the battery pack 10 is not attached to the work machine body 102 is described. In this case, the second battery voltage V2 is delivered to the wireless communicator 91 as the power-supply voltage Vble through the first switching element Q1. More specifically, at the time when the second battery 41 is attached to the terminal block 200, the first switching element Q1 is turned off. Therefore, the second battery voltage V2 is first delivered to the wireless communicator 91 through a parasitic diode of the first switching element Q1. The second battery voltage V2 is divided by the first resistor R1 and the second resistor R2. The divided voltage is applied to the gate of the first switching element Q1. This turns on the first switching element Q1. After the first switching element Q1 is turned on, the second battery voltage V2 is delivered to the wireless communicator 91 as the power-supply voltage Vble through the entire first switching element Q1. As a result, the wireless communicator 91 operates even if the battery pack 10 is not attached to the work machine body 102.

The above-described divided voltage is applied to the first control power-supply line. However, each circuit coupled to the first control power-supply line basically operate with the first control voltage Vc1. The above-described divided voltage is sufficiently lower than the second battery voltage V2. Therefore, each circuit coupled to the first control power-supply line does not operate even if it receives the divided voltage.

Next, the operation of the power switching circuit 80 when the battery pack 10 is attached to the work machine body 102 is described. When the battery pack 10 is attached to the work machine body 102, the first control voltage Vc1 and the second control voltage Vc2 are generated. As a result, the first switching element Q1 is turned off and the second switching element Q2 is turned on. Therefore, the second control voltage Vc2 is delivered to the wireless communicator 91 as the power-supply voltage Vble through the second switching element Q2.

That is, the wireless communicator 91 operates with the second electric power of the second battery 41 when the battery pack 10 is not attached to the work machine body 102. On the other hand, the wireless communicator 91 operates with the second control voltage Vc2 when the battery pack 10 is attached to the work machine body 102.

The second control voltage Vc2 is input to a battery detection terminal of the wireless communicator 91. Based on the wireless communicator 91 having received or receiving the second control voltage Vc2, the wireless communicator 91 detects that the battery pack 10 is attached to the work machine body 102. Upon detecting that the battery pack 10 is attached, the wireless communicator 91 performs a specific process related to the electronic locking.

The communication switching circuit 90 is described in more detail. The communication switching circuit 90 includes a first switching circuit 92 and a second switching circuit 93.

The first switching circuit 92 is on a communication path 24a and completes or interrupts the communication path 24a. The first switching circuit 92 includes a first end coupled to the machine communication terminal 24. The first switching circuit 92 includes a second end coupled to a first end of the second switching circuit 93.

More specifically, the first switching circuit 92 of this second embodiment includes a first switch 94 on the communication path 24a. The first switch 94 completes or interrupts the communication path 24a. The first switch 94 includes a first end that electrically corresponds to the first end of the first switching circuit 92, and a second end that electrically corresponds to the second end of the first switching circuit 92.

The second switching circuit 93 is on the communication path 24a and completes or interrupts the communication path 24a. The second switching circuit 93 includes the first end coupled to the second end of the first switching circuit 92. The second switching circuit 93 includes a second end coupled to the fourth relay terminal 44.

More specifically, the second switching circuit 93 of this second embodiment includes a second switch 95 on the communication path 24a. The second switch 95 completes or interrupts the communication path 24a. The second switch 95 includes a first end that electrically corresponds to the first end of the second switching circuit 93, and a second end that electrically corresponds to the second end of the second switching circuit 93.

The communication path 24a includes an intermediate path. The intermediate path corresponds to the communication path 24a between the first switching circuit 92 and the second switching circuit 93. The intermediate path is coupled to the wireless communicator 91.

The wireless communicator 91 controls the first switching circuit 92 and the second switching circuit 93 (more specifically, controls the first switch 94 and the second switch 95). In this second embodiment, turning on/off the first switching circuit 92 is equivalent to turning on/off the first switch 94, and turning on/off the second switching circuit 93 is equivalent to turning on/off the second switch 95.

The wireless communicator 91 can turn on or off the first switch 94 and the second switch 95 individually. When the first switch 94 and the second switch 95 are turned on, the BMU 17 and the controller 53 can communicate with each other through the communication path 24a. When the first switch 94 is turned off and the second switch 95 is turned on, the wireless communicator 91 and the controller 53 can communicate with each other through the second switch 95. When the second switch 95 is turned off and the first switch 94 is turned on, the wireless communicator 91 and the BMU 17 can communicate with each other through the first switch 94.

The wireless communicator 91 basically turns on the first switch 94 and the second switch 95. The first switch 94 and the second switch 95 may be configured to be on when they are not controlled by the wireless communicator 91. That is, in this second embodiment, the first switch 94 and the second switch 95 are normally turned on, thereby allowing the BMU 17 and the controller 53 to communicate with each other through the communication path 24a. At this time, the communication data transmitted and received between the BMU 17 and the controller 53 is also input to the wireless communicator 91 through the intermediate path. Therefore, the wireless communicator 91 can monitor the communication data.

On the other hand, when the wireless communicator 91 needs to communicate with the BMU 17 or the controller 53, the wireless communicator 91 turns on only one of the first switch 94 and the second switch 95. Then, the wireless communicator 91 communicates with the communication target (the BMU 17 or the controller 53) through the switch that is turned on.

### (2-2-3) Electronic Locking and Unlocking

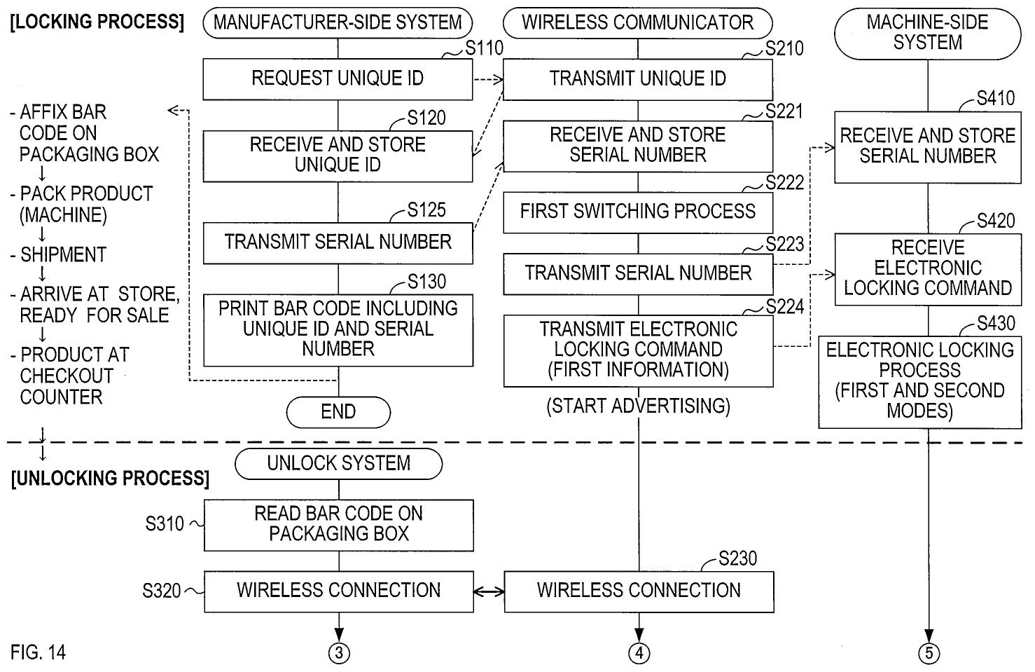

Next, a description is made of an example of a process flow in which the electric work machine 101 is electronically locked and subsequently unlocked. Specifically, the description will focus mainly on the control of the communication switching circuit 90 by the wireless communicator 91, with reference to FIGS. 14 through 16.

A part of the steps shown in FIGS. 14 through 16 are the same as those shown in FIGS. 11 and 12 of the first embodiment. Thus, the steps that are different from those of the first embodiment are mainly described below.

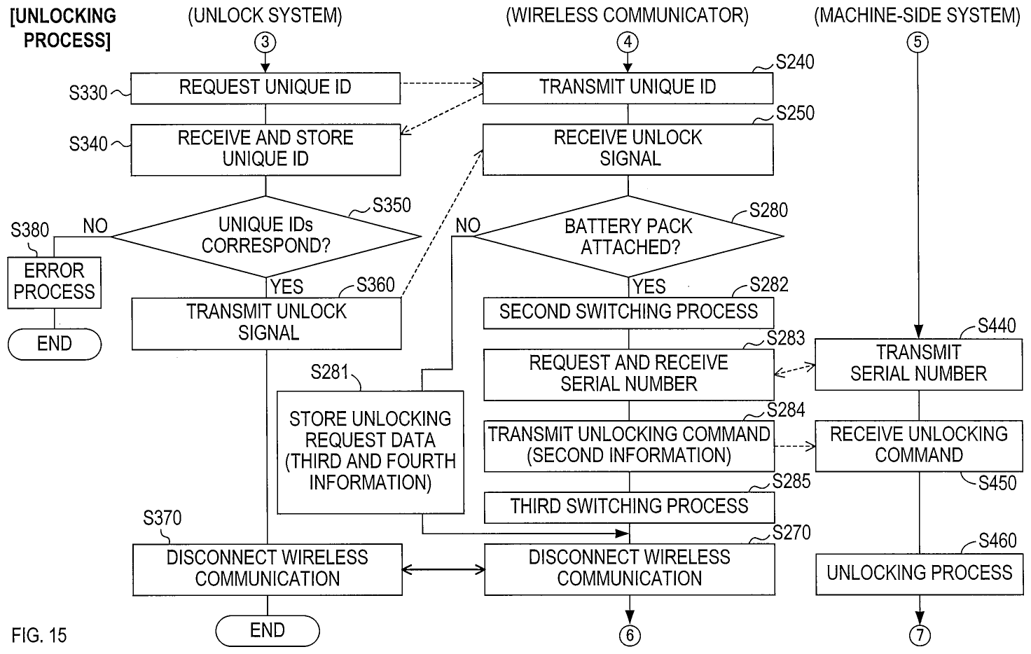

In FIGS. 14 and 15, “machine-side system” means the controller 53 and/or the BMU 17. That is, the controller 53 and the BMU 17 respectively implement the process of “the machine-side system” shown in FIGS. 14 and 15 according to a computer program. The computer program is included in the above-described first program and the second program.

As described above, in this second embodiment, the electronic locking is substantially performed by the controller 53 and/or the BMU 17. The controller 53 and the BMU 17 respectively perform the electronic locking according to the computer program. The electronic locking may be performed by only one of the controller 53 and the BMU 17. However, in the following description, an example in which the electronic locking is performed by both the controller 53 and the BMU 17 is illustrated.

As shown in FIG. 14, when the manufacturer-side system 151 receives and stores the unique ID from the wireless communicator 91 via wireless communication in S120, the manufacturer-side system 151 transmits a serial number to the wireless communicator 91 via wireless communication (S125).

When the wireless communicator 91 receives and stores the serial number from the manufacturer-side system 151 (S221), the wireless communicator 91 performs a first switching process (S222). Specifically, the wireless communicator 91 turns off the first switch 94 and turns on the second switch 95. After the first switching process is performed, the wireless communicator 91 transmits the serial number stored in S221 to the controller 53 through the communication switching circuit 90 (more specifically, through the second switch 95) (S223). After the process of S223, the wireless communicator 91 transmits an electronic locking command to the controller 53 through the communication switching circuit 90 (more specifically, through the second switch 95) (S224).

After transmitting the electronic locking command to the controller 53, the wireless communicator 91 also performs the steps from S222 through S224 in the same manner for the BMU 17. Specifically, the wireless communicator 91 turns on the first switch 94 and turns off the second switch 95 (S222). Then, the wireless communicator 91 transmits the serial number and the electronic locking command to the BMU 17 through the communication switching circuit 90 (more specifically, through the first switch 94) (S223 through S224). Contrary to the above, the step from S222 through S224 may be performed first for the BMU 17 and then the steps from S222 through S224 are performed for the controller 53. When the wireless communicator 91 completes the transmission of the electronic locking command, the wireless communicator 91 resumes advertising.

When the machine-side system (here, each of the controller 53 and the BMU 17) receives the serial number from the wireless communicator 91, the machine-side system stores the serial number (S410). Then, when the machine-side system receives the electronic locking command from the wireless communicator 91 (S420), the machine-side system performs an electronic locking process (S430). Specifically, the BMU 17 sets the BMU 17 to a first mode, and the controller 53 sets the controller 53 to a second mode.

More specifically, the controller 53 stores the received serial number and electronically locks the controller 53 itself (i.e., sets itself to the second mode). Specifically, the controller 53 sets the controller 53 itself not to drive the motor 50 even if the controller 53 receives the discharge permission signal and the trigger 5 is manually operated. That is, the controller 53 electronically locks itself through a software process. The controller 53 may perform the electronic locking in other ways. The same can be applied to the electronic locking performed by the BMU 17, which is described below.

Similarly, the BMU 17 stores the received serial number and electronically locks the BMU 17 itself (i.e., sets itself to the first mode). As a result, the first electric power of the first battery 16 is not delivered to the work machine body 102. The battery pack 10 may electronically lock itself in any way. For example, in this second embodiment, the BMU 17 sets itself so that the BMU 17 does not output the discharge permission signal (or outputs the discharge prohibition signal) even in a state where a discharge from the first battery 16 is possible. This causes the controller 53 not to drive the motor 50 even if the trigger 5 is manually operated based on the controller 53 not receiving the discharge permission signal.

Next, with reference to FIG. 15, the process after S250 in the wireless communicator 91 is described. In this second embodiment, upon receiving an unlock signal from the unlock system 152 (S250), the wireless communicator 91 determines whether the battery pack 10 is attached to the work machine body 102 (S280). The determination in S280 may be made in any way. For example, the determination in S280 may be made based on whether the second control voltage Vc2 is input to the wireless communicator 91. The wireless communicator 91 may determine that the battery pack 10 is attached to the work machine body 102 based on the wireless communicator 91 receiving the second control voltage Vc2.

If the wireless communicator 91 determines that the battery pack 10 is attached to the work machine body 102, the wireless communicator 91 performs a second switching process (S282). Specifically, the wireless communicator 91 turns off the first switch 94 and turns on the second switch 95.

After performing the second switching process, the wireless communicator 91 requests the controller 53 for the serial number and receives the serial number from the controller 53 (S283).

Specifically, the wireless communicator 91 transmits a serial number transmission command to the controller 53 through the communication switching circuit 90 (more specifically, through the second switch 95). The serial number transmission command requests the controller 53 to transmit the serial number stored in the controller 53 to the wireless communicator 91.

Upon receiving the request for the serial number from the wireless communicator 91, the controller 53 transmits the serial number stored in the controller 53 to the wireless communicator 91 (S440). The transmitted serial number is received by the wireless communicator 91 (S283) through the communication switching circuit 90 (more specifically, through the second switch 95) in the terminal block 200.

After receiving the serial number, the wireless communicator 91 transmits an unlocking command to the controller 53 through the communication switching circuit 90 (more specifically, through the second switch 95) (S284). The unlocking command requests that the electronic locking be unlocked.

The wireless communicator 91 further performs a third switching process (S285). Specifically, the wireless communicator 91 turns on both the first switch 94 and the second switch 95.

After performing the steps from S282 through S285 for the controller 53 in this manner, the wireless communicator 91 also performs the steps from S282 through S285 for the BMU 17 in the same manner. Specifically, the wireless communicator 91 turns on the first switch 94 and turns off the second switch 95 (S282). The wireless communicator 91 then communicates with the BMU 17 through the communication switching circuit 90 (more specifically, through the first switch 94) (S283 through S285).

Contrary to the above, the steps from S282 through S285 may be performed first for the BMU 17 and then the steps from S282 through S285 may be performed for the controller 53.

After performing the steps from S282 through S285 for each of the controller 53 and the BMU 17, the wireless communicator 91 disconnects the wireless connection between itself and the unlock system 152 (S270).

When the wireless communicator 91 determines that the battery pack 10 is not attached to the work machine body 102 in S280, the wireless communicator 91 stores unlocking request data (or fourth information) intended for the controller 53 and the unlocking request data (or third information) intended for the BMU 17 (S281). These unlocking request data indicate a state in which the electronic locks can be unlocked.

After receiving the serial number in S283, the wireless communicator 91 may confirm whether the serial number corresponds to the serial number stored in the wireless communicator 91. When the wireless communicator 91 confirms that the serial numbers correspond to each other, the wireless communicator 91 may transmit the unlocking command in S284. When the wireless communicator 91 confirms that the serial numbers do not correspond to each other, the wireless communicator 91 may store the unlocking request data and proceed to S285 without transmitting the unlocking command. The unlocking request data stored here is intended for the machine-side system from which the received serial number was transmitted.

Upon receiving the unlocking command from the wireless communicator 91 (S450), the controller 53 and the BMU 17 each perform an unlocking process (S460).

Specifically, the controller 53 unlocks the electronic lock activated within itself. More specifically, the controller 53 sets itself to drive the motor 50 when (i) the discharge permission signal is received and (ii) the trigger 5 is manually operated. The BMU 17 unlocks the electronic lock activated within itself. Specifically, the BMU 17 sets itself to output the discharge permission signal if the first battery 16 is in the dischargeable state.

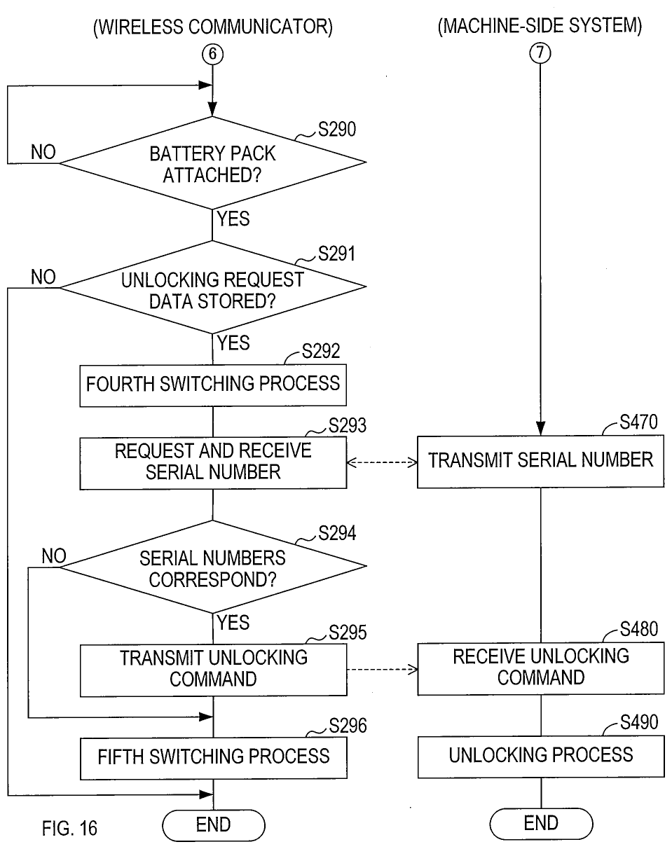

After disconnecting the wireless connection between the wireless communicator 91 and the unlock system 152 in S270, the wireless communicator 91 determines whether the battery pack 10 is attached to the work machine body 102 as shown in FIG. 16 (S290).

If the battery pack 10 is attached, the wireless communicator 91 determines whether the unlocking request data is stored in itself (S291). If the unlocking request data is not stored, the wireless communicator 91 terminates this process. The fact that the unlocking request data is not stored means that both electronic locks of the controller 53 and the BMU 17 have already been unlocked.

If the unlocking request data intended for the controller 53 is stored, the wireless communicator 91 performs a fourth switching process (S292). Specifically, the wireless communicator 91 controls the communication switching circuit 90 so that the wireless communicator 91 can communicate with the controller 53. If the unlocking request data intended for the BMU 17 is stored, the wireless communicator 91 controls the communication switching circuit 90 so that the wireless communicator 91 can communicate with the BMU 17 in S292.

Here, a description is continued by assuming that a target device of the unlocking request data is the controller 53.

In this case, the wireless communicator 91 turns off the first switch 94 and turns on the second switch 95 in S292. After performing the fourth switching process, the wireless communicator 91 requests the controller 53 for the serial number and receives the serial number from the controller 53 (S293). This process in S293 is the same as that in S283. Based on the request for the serial number being received from the wireless communicator 91 (S470), the controller 53 transmits the serial number to the wireless communicator 91. This process in S470 is the same as that in S440.

The wireless communicator 91 confirms whether the received serial number corresponds to the serial number stored in the wireless communicator 91 (S294). When the serial numbers correspond to each other, the wireless communicator 91 transmits the unlocking command to the controller 53 through the communication switching circuit 90 (S295).

After transmitting the unlocking command in S295, the wireless communicator 91 clears (e.g., deletes) the unlocking request data intended for the controller 53. When the electronic lock is properly unlocked, the controller 53 may notify the wireless communicator 91 that the electronic lock is properly unlocked. In response to the notification being received from the controller 53, the wireless communicator 91 may clear the unlocking request data intended for the controller 53.

In S294, if the serial number received does not correspond to the serial number stored in the wireless communicator 91, the wireless communicator 91 proceeds to S296 without transmitting the unlocking command.

In S296, the wireless communicator 91 performs a fifth switching process. Specifically, the wireless communicator 91 turns on both the first switch 94 and the second switch 95 as in S285.

When the unlocking request data determined to be stored in S291 is intended for the BMU 17, the wireless communicator 91 also performs the process from S292 through S296 in the same manner for the BMU 17. In S291, when both of the unlocking request data intended for the controller 53 and the unlocking request data intended for the BMU 17 are stored, the wireless communicator 91 performs the steps from S292 through S296 for each unlocking request data.

The controller 53 and/or the BMU 17 perform an unlocking process (S490) based on receiving the unlocking command (S480) transmitted from the wireless communicator 91 in S295. The unlocking process of S490 is the same as that in S460.

Example of a case where it is determined that the battery pack 10 is not attached in S280 may include (i) a case where the battery pack 10 is not physically and actually attached to the work machine body 102, and/or (ii) a case where the battery pack 10 is attached to the work machine body 102 but the remaining energy of the first battery 16 is insufficient. In these cases, the customer who purchased the electric work machine 1 takes the electric work machine 1 home with the electronic lock being unlocked. When a battery pack 10 with sufficient remaining energy is attached after the purchase, the unlocking command is transmitted after the process from S291 through S294 (S295). As a result, the unlocking process is performed (S490).

In this case, there is a possibility that a battery pack different from the battery pack 10, which is an accompanying item of the purchased product (here, the electric work machine 101), may be attached to the work machine body 102. In this case, a negative determination is made in S294, and the transmission of the unlocking command in S295 is not performed. Therefore, the unlocking request data intended for the BMU 17 is not cleared.

### (2-2-4) Correspondence Between Terms

The serial communication is an example of the second communication protocol in the present disclosure. The second control voltage Vc2 is an example of the power-supply power in the present disclosure. The power switching circuit 80 is an example of the communication power supply circuit in the present disclosure. The unlocking request data (see S281) is an example of the third information and the fourth information in the present disclosure. The state in which the BMU 17 is electronically locked is an example of the first mode in the present disclosure. The state in which the controller 53 is electronically locked is an example of the second mode in the present disclosure.

### 3. Other Embodiments

Some embodiments of the present disclosure have been described; however, the present disclosure may be embodied in various forms without being limited to the above-described embodiments.

(3-1) In the first embodiment, the main board 33 may be arranged anywhere in the terminal block 20. For example, the main board 33 may be arranged in an area other than the front end side of the first holder 31 (e.g., on a rear end side). The main board 33 may be arranged on the second holder 32. The same applies to the second embodiment.

(3-2) The wireless communicator 42 may be mounted on a circuit board distinct from the main board 33 (e.g., the relay board 36). That is, the wireless communicator 42 may be arranged on any part of the terminal block 20. The wireless communicator 42 may be mounted on the relay board 36, for example, or may be arranged on a part different from the main board 33 and the relay board 36. The wireless communicator 42 may be arranged on the second surface 31b of the first holder 31 or on the second surface 32b of the second holder 32.

(3-3) The battery holder 40 may be formed in any part of the terminal block 20. For example, the battery holder 40 may be formed on the first surface 32a of the second holder 32. That is, the second battery 41 may be mountable and removable from a first surface 32a side. For example, the battery holder 40 may be formed on the first surface 31a of the first holder 31. That is, the second battery 41 may be mountable and removable from a first surface 31a side.

(3-4) The cover 38 covering the battery holder 40 may be omitted.

(3-5) In the first embodiment, the electronic locking may be performed, for example, by interrupting the communication path 24a. That is, in the first embodiment, a switching circuit similar to the first switching circuit 92 of the second embodiment may be arranged on the communication path 24a. The electronic lock may be locked by turning off the switching circuit, thereby interrupting the communication path 24a. In this case, the fact that the controller 53 can perform a specific data communication with the BMU 17 may be a requirement for driving the motor 50. That is, for example, the controller 53 may attempt to perform the specific data communication with the BMU 17 when the trigger 5 is manually operated. Then, when the data communication is successful, the controller 53 may drive the motor 50. On the other hand, when the data communication is not successful, the controller 53 does not have to drive the motor 50 even if the controller has received the discharge permission signal.

In the first embodiment, the electronic locking may be performed by interrupting a path between the machine positive electrode terminal 21 and the first relay terminal 26, or a path between the machine negative electrode terminal 22 and the second relay terminal 27, for example. Also in this case, the electronic locking can be performed by arranging a switch on the path and turning off the switch.

(3-6) Each of the first switch 94 and the second switch 95 in the second embodiment may be in any form that they can complete and interrupt the communication path 24a. The first switch 94 and the second switch 95 may be in the form of a so-called bidirectional buffer, for example.

(3-7) The power switching circuit 80 of the second embodiment may be mounted on the terminal block 20 of the first embodiment. That is, the first embodiment may also be configured so that the wireless communicator 42 operates with the second control voltage Vc2 when the battery pack 10 is attached.

(3-8) In the second embodiment, the power switching circuit 80 may be omitted. The wireless communicator 91 may operate with the second electric power of the second battery 41 even when the battery pack 10 is attached.

(3-9) In the terminal block 20, the first machine signal terminal 23, the machine communication terminal 24 and/or the second machine signal terminal 25 may be omitted. The terminal block 20 may include another one or more terminals instead of the first machine signal terminal 23, the machine communication terminal 24, and/or the second machine signal terminal 25.

(3-10) Two or more functions of one element of the above-described embodiment may be achieved by two or more elements, and one function of one element may be achieved by two or more elements. Furthermore, two or more functions of two or more elements may be achieved by one element, and one function achieved by two or more elements may be achieved by one element. A part of the configurations of the above-described embodiments may be omitted. Furthermore, at least a part of the configurations of the above-described embodiments may be added to or replaced by another configuration of the above-described embodiments.

What is claimed is:

1. A battery-powered device comprising:
a grip configured to be gripped by a user of the battery-powered device;
a trigger configured to be manually moved by the user;
a battery pack including
a first battery including a positive electrode and a negative electrode,
a positive electrode connection terminal electrically coupled to the positive electrode,
a negative electrode connection terminal electrically coupled to the negative electrode,
a first battery signal terminal,
a second battery signal terminal, and
a battery communication terminal,
a battery port configured to detachably attach the battery pack thereto;
a motor configured to receive a first electric power of the first battery from the battery pack to thereby rotate;
a chuck sleeve configured (i) to be driven by the motor and (ii) to detachably attach a tool bit thereto;
a controller configured to control the motor; and
a terminal block including
a machine positive electrode terminal configured to be coupled to the positive electrode connection terminal,
a machine negative electrode terminal configured to be coupled to the negative electrode connection terminal,
a first machine signal terminal configured to be coupled to the first battery signal terminal,
a second machine signal terminal configured to be coupled to the second battery signal terminal,
a machine communication terminal configured to be coupled to the battery communication terminal,
a holding body holding the machine positive electrode terminal, the machine negative electrode terminal, the first machine signal terminal, the second machine signal terminal, and the machine communication terminal,
a battery holder (i) in the holding body and (ii) configured to removably hold a second battery, and
a wireless communicator (i) on the holding body, (ii) configured to receive a second electric power from the second battery and (iii) configured to wirelessly communicate with an external system distinct from the battery-powered device.

2. A battery-powered device comprising:
a battery port configured to detachably attach a battery pack thereto, the battery pack including a first battery and two or more battery-side terminals;
an electric load configured to receive a first electric power of the first battery from the battery pack to thereby operate;
a controller configured to control the electric load; and
a terminal block including
two or more machine-side terminals configured (i) to be coupled to the two or more battery-side terminals, respectively, and (ii) to receive the first electric power through the two or more battery-side terminals, based on the battery pack being attached to the battery port,
a battery holder configured to removably hold a second battery, and
a wireless communicator configured (i) to receive second electric power from the second battery and (ii) to perform a wireless communication.

3. The battery-powered device according to claim 2,
wherein the terminal block further includes a holding body (i) holding the two or more machine-side terminals and (ii) including a first surface and a second surface corresponding to a front surface and a back surface of the holding body, the second surface (i) being configured to face the battery pack based on the battery pack being attached to the battery port, and (ii) including a terminal arrangement area in which the two or more machine-side terminals are arranged.

4. The battery-powered device according to claim 3,
wherein the battery holder is on the second surface.

5. The battery-powered device according to claim 4,
wherein the second surface includes a holder arrangement area distinct from the terminal arrangement area, and
wherein the battery holder is in the holder arrangement area.

6. The battery-powered device according to claim 2,
wherein the battery port is configured to attach the battery pack thereto by sliding the battery pack in a first direction on the battery port, and
wherein the battery holder is spaced apart from the two or more battery-side terminals in the first direction in a pack attached state and the pack attached state corresponds to a state where the battery pack is attached to the battery port.

7. The battery-powered device according to claim 2,
wherein the wireless communicator is spaced apart from the battery holder.

8. The battery-powered device according to claim 3,
wherein the wireless communicator is on the first surface.

9. The battery-powered device according to claim 2,
wherein the terminal block further includes a cover configured to cover the battery holder.

10. The battery-powered device according to claim 9,
wherein the cover is configured to be fixed to the terminal block by a screw.

11. The battery-powered device according to claim 9,
wherein the terminal block further includes
a cover receiving surface configured to face the cover, and
a sealing member (i) on the cover or on the cover receiving surface and (ii) configured to be in close contact with both the cover and the cover receiving surface based on the battery holder being covered by the cover, thereby sealing the battery holder together with the cover.

12. The battery-powered device according to claim 2,
wherein the wireless communicator is configured to:
forcibly set the battery-powered device to an inoperable state based on having received first information via the wireless communication, the inoperable state corresponding to a state where the electric load cannot operate; and
cancel the inoperable state based on (i) the battery-powered device being in the inoperable state and (ii) having received second information via the wireless communication.

13. The battery-powered device according to claim 12,
wherein the two or more machine-side terminals include an information input terminal configured to receive permission information from the battery pack, the permission information indicating permission for an operation of the electric load,
wherein the controller is configured to operate the electric load based on (i) having received a command of the operation of the electric load and (ii) having received the permission information through the information input terminal, and
wherein the wireless communicator is configured to interrupt an input of the permission information to the controller to thereby set the battery-powered device to the inoperable state.

14. The battery-powered device according to claim 13,
wherein the terminal block further includes
an information transmission path configured to transmit, to the controller, the permission information input to the information input terminal and
a first switch configured to complete or interrupt the information transmission path, and
wherein the wireless communicator is configured to
cause the first switch to interrupt the information transmission path to thereby set the battery-powered device to the inoperable state, and
cause the first switch to complete the information transmission path to thereby cancel the inoperable state.

15. A method for installing a wireless communicator in a battery-powered device, the method comprising:
providing the wireless communicator to a terminal block, the terminal block including a machine-side terminal configured to be coupled to a battery-side terminal of a battery pack, and the battery pack being configured to be detachably coupled to the battery-powered device; and
providing the terminal block equipped with the wireless communicator to the battery-powered device.

16. The method according to claim 15, further including:
providing a battery holder to the terminal block, the battery holder being configured to removably hold a second battery that is distinct from the battery pack, and the wireless communicator being configured to receive an electric power from the second battery to thereby operate.
